(19) United States
(12) Patent Application Publication
(10) Pub. No.: US 2026/0189988 A1
(43) Pub. Date: Jul. 2, 2026

(54) COMMUNICATION METHOD AND COMMUNICATION APPARATUS

(71) Applicant: HUAWEI TECHNOLOGIES CO., LTD., Shenzhen (CN)

(72) Inventors: Yu Wang, Hangzhou (CN); Yunfei Qiao, Hangzhou (CN); Jiayin Zhang, Shanghai (CN); Chuili Kong, Hangzhou (CN); Ying Chen, Hangzhou (CN)

(21) Appl. No.: 19/547,915

(22) Filed: Feb. 24, 2026

Related U.S. Application Data
(63) Continuation of application No. PCT/CN2024/114297, filed on Aug. 23, 2024.

(30) Foreign Application Priority Data
Aug. 25, 2023 (CN) 202311086821.7

(51) Int. Cl. H04W 36/00; H04W 56/00; H04W 74/0833; H04W 84/06; H04W 92/24

(52) U.S. Cl. CPC H04W 36/0016; H04W 56/0015; H04W 74/0833; H04W 84/06; H04W 92/24

(57) ABSTRACT

This application provides a communication method and a communication apparatus, and may be applied to a non-terrestrial communication network. In the method, a first terminal device receives first information and second information from a first node, where the first information includes common information for performing mobility management on at least one terminal device in at least one zone corresponding to a second node, the second information includes dedicated information for performing mobility management on the first terminal device, the at least one zone includes a zone served by the first node, and the at least one terminal device includes the first terminal device; the first terminal device performs, based on the first information and the second information, a mobility management procedure in the zone served by the first node; and the first terminal device receives updated second information from the first node.

### CROSS-REFERENCE TO RELATED APPLICATIONS

This application is a continuation of International Application No. PCT/CN2024/114297, filed on Aug. 23, 2024, which claims priority to Chinese Patent Application No. 202311086821.7, filed on Aug. 25, 2023. The disclosures of the aforementioned applications are hereby incorporated by reference in their entireties.

### TECHNICAL FIELD

This application relates to the field of non-terrestrial communication technologies such as a satellite network, and more specifically, to a communication method and a communication apparatus.

### BACKGROUND

A non-terrestrial network (NTN) includes nodes such as a satellite network, a high altitude platform, and an uncrewed aerial vehicle, and forms, together with a 5th generation (5G) communication system, a global sea-land-space-air-ground integrated comprehensive communication network that provides seamless coverage, to meet various service requirements.

In the non-terrestrial network (for example, a beam hopping satellite communication system), movement of a satellite node may cause group handover or group reselection of user equipment (UE) in a zone. In group handover/group reselection triggered mainly by network (for example, satellite) mobility, overheads of signaling transmitted between a source node and a destination node are extremely high, and efficiency of group handover/group reselection is low. For example, a single satellite covers 1.72×10⁶ square kilometers, and an average service time is 5 minutes. It is assumed that there are 10 UEs in a radio resource control (RRC) connected state per square kilometer. Inter-satellite (namely, a source node and a destination node) exchange signaling overheads caused by handover of a single UE are about 23 Kbits, and inter-satellite signaling overheads caused by handover of a UE group may reach several Gbps or even dozens of Gbps. Therefore, how to perform efficient and low-overhead mobility management of UE in an NTN scenario is a problem that needs to be considered.

### SUMMARY

This application provides a communication method and a communication apparatus, to reduce signaling overheads of mobility management of a terminal device in an NTN scenario.

According to a first aspect, a communication method is provided. The method may be performed by a first terminal device, or may be performed by a chip or a circuit configured in the first terminal device. This is not limited in this application. The following uses an example in which the first terminal device performs the method for description.

The method includes: A first terminal device receives first information and second information from a first node, where the first information includes common information for performing mobility management on at least one terminal device in at least one zone corresponding to a second node, the second information includes dedicated information for performing mobility management on the first terminal device, the at least one zone includes a zone served by the first node, and the at least one terminal device includes the first terminal device; the first terminal device performs, based on the first information and the second information, a mobility management procedure in the zone served by the first node; and the first terminal device receives updated second information from the first node.

Based on the foregoing solution, information used for mobility management of the terminal device is divided into common information and dedicated information, and only the updated dedicated information of the terminal device is received in the mobility management procedure of the terminal device, so that signaling overheads of the terminal device in the mobility management procedure can be reduced.

With reference to the first aspect, in some implementations of the first aspect, the first node may be a node in an NTN, and the first node may bear some functions of a base station, for example, bear some or all functions of a gNB-DU.

With reference to the first aspect, in some implementations of the first aspect, the first node is a first satellite, and the second node is a second satellite or a terrestrial station corresponding to the first satellite.

With reference to the first aspect, in some implementations of the first aspect, the first information includes at least one of the following information: an identity of an interface F1 application protocol AP between the first node and at least one node, a common measurement configuration, a common cell group configuration, a common radio bearer configuration, and a common reconfiguration with synchronization; the at least one node includes the first node; and the second information includes at least one of the following information: a dedicated measurement configuration of the first terminal device, a dedicated cell group configuration of the first terminal device, a dedicated radio bearer configuration of the first terminal device, and a dedicated reconfiguration with synchronization of the first terminal device.

With reference to the first aspect, in some implementations of the first aspect, the common measurement configuration includes at least one of the following information: a synchronization signal block-based measurement timing configuration SMTC, position information of the second node, and a measurement priority of the at least one zone; and the common reconfiguration with synchronization includes at least one of the following information: a time domain configuration, a preamble, or a frequency domain configuration of a random access channel occasion RO corresponding to target zone access in the mobility management procedure, and a validity period of the F1 AP.

With reference to the first aspect, in some implementations of the first aspect, the dedicated measurement configuration includes at least one of the following: a plurality of synchronization signal block-based measurement timing configurations SMTC, a synchronization signal block-based measurement timing configuration SMTC periodicity extension factor or a synchronization signal block-based measurement timing configuration SMTC offset, and ephemeris information of the first node; and the dedicated reconfiguration with synchronization includes at least one of the following information: an extension factor and/or a quantity of consecutive frames of a random access channel occasion RO corresponding to target zone access in the mobility management procedure, and an offset of a validity period of the F1 AP.

With reference to the first aspect, in some implementations of the first aspect, the first terminal device receives the first information and the second information from the first node in an initial access procedure of the first terminal device.

According to a second aspect, a communication method is provided. The method may be performed by a first node, or may be performed by a chip or a circuit configured in the first node. This is not limited in this application. The following uses an example in which the first node performs the method for description.

The method includes: A first node sends first information and second information to a first terminal device, where the first information includes common information for performing mobility management on at least one terminal device in at least one zone corresponding to a second node, the second information includes dedicated information for performing mobility management on the first terminal device, the at least one zone includes a zone served by the first node, and the at least one terminal device includes the first terminal device; the first node performs, based on a measurement report, a mobility management procedure of the first terminal device in the zone served by the first node, where the measurement report is determined based on the first information and the second information; and the first node sends updated second information to the first terminal device.

Based on the foregoing solution, information used for mobility management of the terminal device is divided into common information and dedicated information, and only the updated dedicated information of the terminal device is sent in the mobility management procedure of the terminal device, so that signaling overheads of the first node in the mobility management procedure can be reduced.

With reference to the second aspect, in some implementations of the second aspect, the first node may be a node in an NTN, and the first node may bear some functions of a base station, for example, bear some or all functions of a gNB-DU.

With reference to the second aspect, in some implementations of the second aspect, the first node is a first satellite, and the second node is a second satellite or a terrestrial station corresponding to the first satellite.

With reference to the second aspect, in some implementations of the second aspect, the first information includes at least one of the following information: an identity of an interface F1 application protocol AP between the second node and at least one node, a common measurement configuration, a common cell group configuration, a common radio bearer configuration, and a common reconfiguration with synchronization; the at least one node includes the first node; and the second information includes at least one of the following information: a dedicated measurement configuration of the first terminal device, a dedicated cell group configuration of the first terminal device, a dedicated radio bearer configuration of the first terminal device, and a dedicated reconfiguration with synchronization of the first terminal device.

With reference to the second aspect, in some implementations of the second aspect, the common measurement configuration includes at least one of the following information: a synchronization signal block-based measurement timing configuration SMTC, position information of the second node, and a measurement priority of the at least one zone; and the common reconfiguration with synchronization includes at least one of the following information: a time domain configuration, a preamble, or a frequency domain configuration of a random access channel occasion RO corresponding to target zone access in the mobility management procedure, and a validity period of the F1 AP.

With reference to the second aspect, in some implementations of the second aspect, the dedicated measurement configuration includes at least one of the following: a plurality of synchronization signal block-based measurement timing configurations SMTC, a synchronization signal block-based measurement timing configuration SMTC periodicity extension factor or a synchronization signal block-based measurement timing configuration SMTC offset, and ephemeris information of the first node; and the dedicated reconfiguration with synchronization includes at least one of the following information: an extension factor and/or a quantity of consecutive frames of a random access channel occasion RO corresponding to target zone access in the mobility management procedure, and an offset of a validity period of the F1 AP.

With reference to the second aspect, in some implementations of the second aspect, the method further includes: The first node receives the first information from the second node.

With reference to the second aspect, in some implementations of the second aspect, the first node receives the first information from the second node in an initial access procedure of the first terminal device.

With reference to the second aspect, in some implementations of the second aspect, the first node sends the first information and the second information to the first terminal device in the initial access procedure of the first terminal device.

According to a third aspect, a communication method is provided. The method may be performed by a first terminal device, or may be performed by a chip or a circuit configured in the first terminal device. This is not limited in this application. The following uses an example in which the first terminal device performs the method for description.

The method includes: A first terminal device receives first information and second information from a first node, where the first information includes common information for performing mobility management on at least one terminal device in at least one zone corresponding to a second node, the second information includes dedicated information for performing mobility management on the first terminal device, the at least one zone includes a zone served by the first node, and the at least one terminal device includes the first terminal device; the first terminal device performs, based on the first information and the second information, a mobility management procedure from the zone served by the first node to a first zone, where the first zone is a zone served by a third node; and the first terminal device receives third information from the third node, where the third information includes the dedicated information for performing mobility management on the first terminal device, the third information is determined by the third node, and the at least one zone includes the zone served by the third node.

Based on the foregoing solution, information used for mobility management of the terminal device is divided into common information and dedicated information, and only the dedicated information of the terminal device is received in the mobility management procedure of the terminal device from a zone served by one node to a zone served by another node, so that signaling overheads of the terminal device in the mobility management procedure can be reduced.

With reference to the third aspect, in some implementations of the third aspect, the first node and the third node may be nodes in an NTN, and the first node and the third node may bear some functions of a base station, for example, bear some or all functions of a gNB-DU.

With reference to the third aspect, in some implementations of the third aspect, the first node is a first satellite, the second node is a second satellite or a terrestrial station corresponding to the first satellite, and the third node is a third satellite.

With reference to the third aspect, in some implementations of the third aspect, the first information includes at least one of the following information: an identity of an interface F1 application protocol between the second node and at least one node, a common measurement configuration, a common cell group configuration, a common radio bearer configuration, and a common reconfiguration with synchronization; the at least one node includes the first node and the third node; and the third information includes at least one of the following information: a dedicated measurement configuration of the first terminal device, a dedicated cell group configuration of the first terminal device, a dedicated radio bearer configuration of the first terminal device, and a dedicated reconfiguration with synchronization of the first terminal device.

With reference to the third aspect, in some implementations of the third aspect, the common measurement configuration includes at least one of the following information: a synchronization signal block-based measurement timing configuration SMTC, position information of the second node, and a measurement priority of the at least one zone; and the common reconfiguration with synchronization includes at least one of the following information: a time domain configuration, a preamble, or a frequency domain configuration of a random access channel occasion RO corresponding to target zone access in the mobility management procedure, and a validity period of the F1 AP.

With reference to the third aspect, in some implementations of the third aspect, the dedicated measurement configuration includes at least one of the following: a plurality of SMTCs, an SMTC periodicity extension factor or an SMTC offset, and ephemeris information of the first node; and the dedicated reconfiguration with synchronization includes at least one of the following information: an extension factor and/or a quantity of consecutive frames of a random access channel occasion RO corresponding to target zone access in the mobility management procedure, and an offset of a validity period of the F1 AP.

With reference to the third aspect, in some implementations of the third aspect, the first terminal device receives the first information and the second information from the first node in an initial access procedure of the first terminal device.

According to a fourth aspect, a communication method is provided. The method may be performed by a third node, or may be performed by a chip or a circuit configured in the third node. This is not limited in this application. The following uses an example in which the third node performs the method for description.

The method includes: A third node performs a mobility management procedure of a first terminal device from a zone served by a first node to a first zone, where the first zone is a zone served by the third node, execution of the mobility management procedure is determined based on first information and second information, the first information includes common information for performing mobility management on at least one terminal device in at least one zone corresponding to a second node, the second information includes dedicated information for performing mobility management on the first terminal device, the second information is determined by the first node, the at least one zone includes the zone served by the first node and the zone served by the third node, and the at least one terminal device includes the first terminal device; and the third node sends third information to the first terminal device, where the third information includes the dedicated information for performing mobility management on the first terminal device, and the third information is determined by the third node.

Based on the foregoing solution, information used for mobility management of the terminal device is divided into common information and dedicated information, and only the dedicated information of the terminal device is sent in the mobility management procedure of the terminal device from a zone served by one node to a zone served by another node (for example, the third node), so that signaling overheads of the third node in the mobility management procedure can be reduced.

With reference to the fourth aspect, in some implementations of the fourth aspect, the first node and the third node may be nodes in an NTN, and the first node and the third node may bear some functions of a base station, for example, bear some or all functions of a gNB-DU.

With reference to the fourth aspect, in some implementations of the fourth aspect, the first node is a first satellite, the second node is a second satellite or a terrestrial station corresponding to the first satellite, and the third node is a third satellite.

With reference to the fourth aspect, in some implementations of the fourth aspect, the first information includes at least one of the following information: an identity of an interface F1 application protocol AP between the second node and at least one node, a common measurement configuration, a common cell group configuration, a common radio bearer configuration, and a common reconfiguration with synchronization; the at least one node includes the first node and the third node; and the third information includes at least one of the following information: a dedicated measurement configuration of the first terminal device, a dedicated cell group configuration of the first terminal device, a dedicated radio bearer configuration of the first terminal device, and a dedicated reconfiguration with synchronization of the first terminal device.

With reference to the fourth aspect, in some implementations of the fourth aspect, the common measurement configuration includes at least one of the following information: a synchronization signal block-based measurement timing configuration SMTC, position information of the second node, and a measurement priority of the at least one zone; and the common reconfiguration with synchronization includes at least one of the following information: a time domain configuration, a preamble, or a frequency domain configuration of a random access channel occasion RO corresponding to target zone access in the mobility management procedure, and a validity period of the F1 AP.

With reference to the fourth aspect, in some implementations of the fourth aspect, the dedicated measurement configuration includes at least one of the following: a plurality of synchronization signal block-based measurement timing configurations SMTC, a synchronization signal block-based measurement timing configuration SMTC periodicity extension factor or a synchronization signal block-based measurement timing configuration SMTC offset, and ephemeris information of the first node; and the dedicated reconfiguration with synchronization includes at least one of the following information: an extension factor and/or a quantity of consecutive frames of a random access channel occasion RO corresponding to target zone access in the mobility management procedure, and an offset of a validity period of the F1 AP.

With reference to the fourth aspect, in some implementations of the fourth aspect, the first information and the second information are sent by the first node in an initial access procedure of the first terminal device.

According to a fifth aspect, a communication apparatus is provided. The apparatus includes a transceiver unit and a processing unit, where the transceiver unit is configured to receive first information and second information from a first node, where the first information includes common information for performing mobility management on at least one terminal device in at least one zone corresponding to a second node, the second information includes dedicated information for performing mobility management on the apparatus, the at least one zone includes a zone served by the first node, and the at least one terminal device includes the apparatus; the processing unit is configured to perform, based on the first information and the second information, a mobility management procedure in the zone served by the first node; and the transceiver unit is further configured to receive updated second information from the first node.

With reference to the fifth aspect, in some implementations of the fifth aspect, the first node may be a node in an NTN, and the first node may bear some functions of a base station, for example, bear some or all functions of a gNB-DU.

With reference to the fifth aspect, in some implementations of the fifth aspect, the first node is a first satellite, and the second node is a second satellite or a terrestrial station corresponding to the first satellite.

With reference to the fifth aspect, in some implementations of the fifth aspect, the first information includes at least one of the following information: an identity of an interface F1 application protocol AP between the first node and at least one node, a common measurement configuration, a common cell group configuration, a common radio bearer configuration, and a common reconfiguration with synchronization; the at least one node includes the first node; and the second information includes at least one of the following information: a dedicated measurement configuration of the apparatus, a dedicated cell group configuration of the apparatus, a dedicated radio bearer configuration of the apparatus, and a dedicated reconfiguration with synchronization of the apparatus.

With reference to the fifth aspect, in some implementations of the fifth aspect, the common measurement configuration includes at least one of the following information: a synchronization signal block-based measurement timing configuration SMTC, position information of the second node, and a measurement priority of the at least one zone; and the common reconfiguration with synchronization includes at least one of the following information: a time domain configuration, a preamble, or a frequency domain configuration of a random access channel occasion RO corresponding to target zone access in the mobility management procedure, and a validity period of the F1 AP.

With reference to the fifth aspect, in some implementations of the fifth aspect, the dedicated measurement configuration includes at least one of the following: a plurality of synchronization signal block-based measurement timing configurations SMTC, a synchronization signal block-based measurement timing configuration SMTC periodicity extension factor or a synchronization signal block-based measurement timing configuration SMTC offset, and ephemeris information of the first node; and the dedicated reconfiguration with synchronization includes at least one of the following information: an extension factor and/or a quantity of consecutive frames of a random access channel occasion RO corresponding to target zone access in the mobility management procedure, and an offset of a validity period of the F1 AP.

With reference to the fifth aspect, in some implementations of the fifth aspect, the apparatus receives the first information and the second information from the first node in an initial access procedure of the apparatus.

According to a sixth aspect, a communication apparatus is provided. The apparatus includes a transceiver unit and a processing unit, where the transceiver unit is configured to send first information and second information to a first terminal device, where the first information includes common information for performing mobility management on at least one terminal device in at least one zone corresponding to a second node, the second information includes dedicated information for performing mobility management on the first terminal device, the at least one zone includes a zone served by the apparatus, and the at least one terminal device includes the first terminal device; the processing unit is configured to perform, based on a measurement report, a mobility management procedure of the first terminal device in the zone served by the apparatus, where the measurement report is determined based on the first information and the second information; and the transceiver unit is further configured to send updated second information to the first terminal device.

With reference to the sixth aspect, in some implementations of the sixth aspect, the apparatus may be a node in an NTN, and the apparatus may bear some functions of a base station, for example, bear some or all functions of a gNB-DU.

With reference to the sixth aspect, in some implementations of the sixth aspect, the apparatus is a first satellite, and the second node is a second satellite or a terrestrial station corresponding to the first satellite.

With reference to the sixth aspect, in some implementations of the sixth aspect, the first information includes at least one of the following information: an identity of an interface F1 application protocol AP between the second node and at least one node, a common measurement configuration, a common cell group configuration, a common radio bearer configuration, and a common reconfiguration with synchronization; the at least one node includes the apparatus; and the second information includes at least one of the following information: a dedicated measurement configuration of the first terminal device, a dedicated cell group configuration of the first terminal device, a dedicated radio bearer configuration of the first terminal device, and a dedicated reconfiguration with synchronization of the first terminal device.

With reference to the sixth aspect, in some implementations of the sixth aspect, the common measurement configuration includes at least one of the following information: a synchronization signal block-based measurement timing configuration SMTC, position information of the second node, and a measurement priority of the at least one zone; and the common reconfiguration with synchronization includes at least one of the following information: a time domain configuration, a preamble, or a frequency domain configuration of a random access channel occasion RO corresponding to target zone access in the mobility management procedure, and a validity period of the F1 AP.

With reference to the sixth aspect, in some implementations of the sixth aspect, the dedicated measurement configuration includes at least one of the following: a plurality of synchronization signal block-based measurement timing configurations SMTC, a synchronization signal block-based measurement timing configuration SMTC periodicity extension factor or a synchronization signal block-based measurement timing configuration SMTC offset, and ephemeris information of the apparatus; and the dedicated reconfiguration with synchronization includes at least one of the following information: an extension factor and/or a quantity of consecutive frames of a random access channel occasion RO corresponding to target zone access in the mobility management procedure, and an offset of a validity period of the F1 AP.

With reference to the sixth aspect, in some implementations of the sixth aspect, the transceiver unit is further configured to: receive the first information from the second node.

With reference to the sixth aspect, in some implementations of the sixth aspect, the transceiver unit is specifically configured to: receive the first information from the second node in an initial access procedure of the first terminal device.

With reference to the sixth aspect, in some implementations of the sixth aspect, the transceiver unit is specifically configured to: send the first information and the second information to the first terminal device in the initial access procedure of the first terminal device.

According to a seventh aspect, a communication apparatus is provided. The apparatus includes a transceiver unit and a processing unit, where the transceiver unit is configured to receive first information and second information from a first node, where the first information includes common information for performing mobility management on at least one terminal device in at least one zone corresponding to a second node, the second information includes dedicated information for performing mobility management on the apparatus, the at least one zone includes a zone served by the first node, and the at least one terminal device includes the apparatus; the processing unit is configured to perform, based on the first information and the second information, a mobility management procedure from the zone served by the first node to a first zone, where the first zone is a zone served by a third node; and the transceiver unit is further configured to receive third information from the third node, where the third information includes the dedicated information for performing mobility management on the apparatus, the third information is determined by the third node, and the at least one zone includes the zone served by the third node.

With reference to the seventh aspect, in some implementations of the seventh aspect, the first node and the third node may be nodes in an NTN, and the first node and the third node may bear some functions of a base station, for example, bear some or all functions of a gNB-DU.

With reference to the seventh aspect, in some implementations of the seventh aspect, the first node is a first satellite, the second node is a second satellite or a terrestrial station corresponding to the first satellite, and the third node is a third satellite.

With reference to the seventh aspect, in some implementations of the seventh aspect, the first information includes at least one of the following information: an identity of an interface F1 application protocol between the second node and at least one node, a common measurement configuration, a common cell group configuration, a common radio bearer configuration, and a common reconfiguration with synchronization; the at least one node includes the first node and the third node; and the third information includes at least one of the following information: a dedicated measurement configuration of the apparatus, a dedicated cell group configuration of the apparatus, a dedicated radio bearer configuration of the apparatus, and a dedicated reconfiguration with synchronization of the apparatus.

With reference to the seventh aspect, in some implementations of the seventh aspect, the common measurement configuration includes at least one of the following information: a synchronization signal block-based measurement timing configuration SMTC, position information of the second node, and a measurement priority of the at least one zone; and the common reconfiguration with synchronization includes at least one of the following information: a time domain configuration, a preamble, or a frequency domain configuration of a random access channel occasion RO corresponding to target zone access in the mobility management procedure, and a validity period of the F1 AP.

With reference to the seventh aspect, in some implementations of the seventh aspect, the dedicated measurement configuration includes at least one of the following: a plurality of SMTCs, an SMTC periodicity extension factor or an SMTC offset, and ephemeris information of the first node; and the dedicated reconfiguration with synchronization includes at least one of the following information: an extension factor and/or a quantity of consecutive frames of a random access channel occasion RO corresponding to target zone access in the mobility management procedure, and an offset of a validity period of the F1 AP.

With reference to the seventh aspect, in some implementations of the seventh aspect, the transceiver unit is specifically configured to receive the first information and the second information from the first node in an initial access procedure of the apparatus.

According to an eighth aspect, a communication apparatus is provided. The apparatus includes a transceiver unit and a processing unit, where the processing unit is configured to perform a mobility management procedure of a first terminal device from a zone served by a first node to a first zone, where the first zone is a zone served by the apparatus, execution of the mobility management procedure is determined based on first information and second information, the first information includes common information for performing mobility management on at least one terminal device in at least one zone corresponding to a second node, the second information includes dedicated information for performing mobility management on the first terminal device, the second information is determined by the first node, the at least one zone includes the zone served by the first node and the zone served by the apparatus, and the at least one terminal device includes the first terminal device; and the transceiver unit is configured to send third information to the first terminal device, where the third information includes the dedicated information for performing mobility management on the first terminal device, and the third information is determined by the apparatus.

With reference to the eighth aspect, in some implementations of the eighth aspect, the first node and the apparatus may be nodes in an NTN, and the first node and the apparatus may bear some functions of a base station, for example, bear some or all functions of a gNB-DU.

With reference to the eighth aspect, in some implementations of the eighth aspect, the first node is a first satellite, the second node is a second satellite or a terrestrial station corresponding to the first satellite, and the apparatus is a third satellite.

With reference to the eighth aspect, in some implementations of the eighth aspect, the first information includes at least one of the following information: an identity of an interface F1 application protocol AP between the second node and at least one node, a common measurement configuration, a common cell group configuration, a common radio bearer configuration, and a common reconfiguration with synchronization; the at least one node includes the first node and the apparatus; and the third information includes at least one of the following information: a dedicated measurement configuration of the first terminal device, a dedicated cell group configuration of the first terminal device, a dedicated radio bearer configuration of the first terminal device, and a dedicated reconfiguration with synchronization of the first terminal device.

With reference to the eighth aspect, in some implementations of the eighth aspect, the common measurement configuration includes at least one of the following information: a synchronization signal block-based measurement timing configuration SMTC, position information of the second node, and a measurement priority of the at least one zone; and the common reconfiguration with synchronization includes at least one of the following information: a time domain configuration, a preamble, or a frequency domain configuration of a random access channel occasion RO corresponding to target zone access in the mobility management procedure, and a validity period of the F1 AP.

With reference to the eighth aspect, in some implementations of the eighth aspect, the dedicated measurement configuration includes at least one of the following: a plurality of synchronization signal block-based measurement timing configurations SMTC, a synchronization signal block-based measurement timing configuration SMTC periodicity extension factor or a synchronization signal block-based measurement timing configuration SMTC offset, and ephemeris information of the first node; and the dedicated reconfiguration with synchronization includes at least one of the following information: an extension factor and/or a quantity of consecutive frames of a random access channel occasion RO corresponding to target zone access in the mobility management procedure, and an offset of a validity period of the F1 AP.

With reference to the eighth aspect, in some implementations of the eighth aspect, the first information and the second information are sent by the first node in an initial access procedure of the first terminal device.

According to a ninth aspect, this application provides a communication apparatus. In a implementation, the communication apparatus may include modules that are in a one-to-one correspondence with the methods/operations/steps/actions according to the first aspect to the fourth aspect or any implementation of the first aspect to the fourth aspect. The modules may be hardware circuits, may be software, or may be implemented by a hardware circuit in combination with software. In a implementation, the communication apparatus may include a processing module and a communication module.

According to a tenth aspect, this application provides a communication apparatus. The communication apparatus includes a processor configured to perform the method according to the first aspect, the third aspect, or any implementation of the first aspect or the third aspect. The processor is coupled to a memory. The memory is configured to store instructions and data. When the processor executes the instructions stored in the memory, the method according to the first aspect, the second aspect, or any implementation of the first aspect or the second aspect can be implemented. Optionally, the communication apparatus may further include the memory. Optionally, the communication apparatus may further include a communication interface. The communication interface is used by the apparatus to communicate with another device. For example, the communication interface may be a transceiver, a hardware circuit, a bus, a module, a pin, or another type of communication interface. In an example, the communication apparatus may be a network device, for example, an access network device, may be an apparatus, a module, a chip, or the like disposed in the network device, or may be an apparatus that can be used in matching with the network device.

According to an eleventh aspect, this application provides a communication apparatus. The communication apparatus includes a processor configured to perform the method according to the second aspect, the fourth aspect, or any implementation of the second aspect or the fourth aspect. The processor is coupled to a memory. The memory is configured to store instructions and data. When the processor executes the instructions stored in the memory, the method according to the third aspect, the fourth aspect, or any implementation of the third aspect or the fourth aspect can be implemented. Optionally, the communication apparatus may further include the memory. Optionally, the communication apparatus may further include a communication interface. The communication interface is used by the apparatus to communicate with another device. For example, the communication interface may be a transceiver, a hardware circuit, a bus, a module, a pin, or another type of communication interface. In an example, the communication apparatus may be a terminal device, may be an apparatus, a module, a chip, or the like disposed in the terminal device, or may be an apparatus that can be used in matching with the terminal device.

According to a twelfth aspect, this application provides a communication system, including a first node and a third node. Optionally, at least one of a terminal device and a second node is further included.

According to a thirteenth aspect, this application further provides a computer program. When the computer program is run on a computer, the computer is enabled to perform the method according to any one of the first aspect to the fourth aspect or the implementations of the first aspect to the fourth aspect.

According to a fourteenth aspect, this application further provides a computer program product, including instructions. When the instructions are run on a computer, the computer is enabled to perform the method according to any one of the first aspect to the fourth aspect or the implementations of the first aspect to the fourth aspect.

According to a fifteenth aspect, this application further provides a computer-readable storage medium. The computer-readable storage medium stores a computer program or instructions. When the computer program or the instructions are run on a computer, the computer is enabled to perform the method according to any one of the first aspect to the fourth aspect or the implementations of the first aspect to the fourth aspect.

According to a sixteenth aspect, this application further provides a chip. The chip is configured to read a computer program stored in a memory, to perform the method according to any one of the first aspect to the fourth aspect or the implementations of the first aspect to the fourth aspect; or the chip includes a circuit configured to perform the method according to any one of the first aspect to the fourth aspect or the first aspect to the fourth aspect.

According to a seventeenth aspect, this application further provides a chip system. The chip system includes a processor, configured to support an apparatus in implementing the method according to any one of the first aspect to the fourth aspect or the implementations of the first aspect to the fourth aspect. In a possible implementation, the chip system further includes a memory, and the memory is configured to store a program and data that are necessary for the apparatus. The chip system may include a chip, or may include a chip and another discrete component.

For technical effects of the solution according to any one of the ninth aspect to the seventeenth aspect or the implementations of the ninth aspect to the seventeenth aspect, refer to the corresponding descriptions in the first aspect.

### BRIEF DESCRIPTION OF DRAWINGS

FIG. 1 is an example diagram of a communication system applicable to this application;

FIG. 2 is an example diagram of an architecture of satellite communication;

FIG. 3 is an example diagram of a beam hopping satellite communication system;

FIG. 4 is an example diagram of a group handover problem in a beam hopping satellite communication system;

FIG. 5 is an example schematic flowchart of a communication method 500 according to this application;

FIG. 6 is an example diagram of service ranges of a first node and a second node;

FIG. 7 is an example schematic flowchart of a communication method 700 according to this application;

FIG. 8 is an example schematic flowchart of initial access according to this application;

FIG. 9 is an example schematic flowchart of a communication method 900 according to this application;

FIG. 10 is an example schematic flowchart of a communication method 1000 according to this application;

FIG. 11 is a block diagram of a communication apparatus 1000 according to an example embodiment of this application;

FIG. 12 is a block diagram of a communication apparatus 2000 according to an example embodiment of this application; and

FIG. 13 is a block diagram of a chip system 3000 according to an example embodiment of this application.

### DESCRIPTION OF EMBODIMENTS

The following describes technical solutions of this application with reference to accompanying drawings.

The technical solutions of this application may be applied to non-terrestrial network (NTN) systems such as a satellite communication system, a high altitude platform (HAPS) communication system, and an uncrewed aerial vehicle, for example, an integrated communication and navigation (IcaN) system, a global navigation satellite system (GNSS), and an ultra-dense low-orbit satellite communication system. The satellite communication system may be integrated with a conventional mobile communication system. For example, the mobile communication system may be a 4th generation (4G) communication system (for example, a long term evolution (LTE) system), a worldwide interoperability for microwave access (WiMAX) communication system, a 5th generation (5G) communication system, a 6th generation (6G) communication system, a possibly applicable future mobile communication system, and the like.

An NTN includes nodes such as a satellite network, a high altitude platform, and an uncrewed aerial vehicle, is significantly characterized by global coverage, long-distance transmission, flexible networking, easy deployment, being not limited by geographical conditions, and the like, and has been widely applied to a plurality of fields such as maritime communication, positioning and navigation, disaster relief, scientific experiments, video broadcasting, and earth observation. A terrestrial 5G network and a satellite network are integrated and complement each other, to together form a global sea-land-space-air-ground integrated communication network that provides seamless coverage, to meet various service requirements of users.

As an important part of the NTN, a next-generation satellite network generally has a trend of being ultra dense and heterogeneous. First, a scale of the satellite network develops from 66 satellites in an Iridium satellite constellation to 720 satellites in a Oneweb satellite constellation, and finally develops to 12000+ satellites in a starlink ultra dense LEO satellite constellation. Second, the satellite network has a heterogeneous feature, and develops from a conventional single-layer communication network to a multi-layer communication network. A communication satellite network tends to have complex and diversified functions, and is gradually compatible with and supports functions such as navigation enhancement, earth observation, and on-orbit processing of multi-dimensional information.

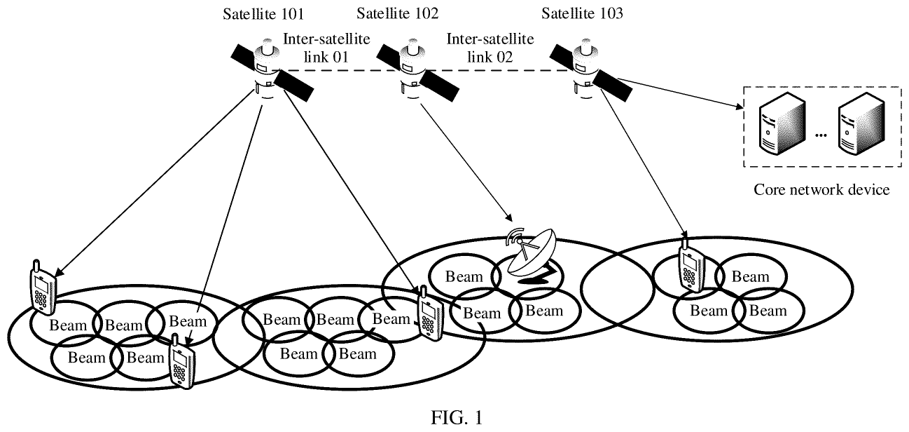

FIG. 1 is a diagram of an NTN communication system applicable to an embodiment of this application. The NTN (satellite) communication system includes a satellite 101, a satellite 102, and a satellite 103. Each satellite may provide a service, for example, a communication service, a navigation service, or a positioning service, for a terminal device by using a plurality of beams. In this scenario, the satellite is a low earth orbit (LEO) satellite. The satellite 103 is connected to a terrestrial station device. The satellite uses a plurality of beams to cover a service zone, and different beams may be used to perform communication in one or more manners of time division, frequency division, and space division. The satellite wirelessly communicates with the terminal device via a broadcast communication signal, a navigation signal, and the like. The satellite can wirelessly communicate with the terrestrial station device.

In addition, the satellite communication system may include a transparent transmission satellite architecture and a non-transparent transmission satellite architecture. Transparent transmission is also referred to as bent-pipe forwarding transmission. To be specific, only processes such as frequency conversion and signal amplification are performed on a signal on a satellite, and the satellite is transparent to the signal. Non-transparent transmission is also referred to as regenerative (on-satellite access/processing) transmission. That is, the satellite has some or all of functions of a base station. For example, the satellite 101 and the satellite 102 in FIG. 1 are of the non-transparent transmission satellite architecture, and the satellite 103 is of the transparent transmission satellite architecture. In addition, the satellite may work in a quasi earth-fixed mode or an earth-moving mode.

The terminal device in embodiments of this application may include various communication kits (where the kit may include, for example, an antenna, a power supply template, a cable, and a Wi-Fi module) having wireless communication functions, a handheld device, a vehicle-mounted device, or another processing device connected to a wireless modem, which may specifically be user equipment (UE), an access terminal, a subscriber unit, a subscriber station, a mobile station, a mobile console, a remote station, a remote terminal, a mobile device, a user terminal, a terminal, a wireless communication device, a user agent, or a user apparatus. Alternatively, the terminal device may be a communication module having a satellite communication function, a satellite phone or a component thereof, a very small aperture terminal (VSAT), a wireless modem, a machine type communication device, or another processing device connected to a wireless modem. Alternatively, the terminal device may be a virtual reality (VR) terminal device, an augmented reality (AR) terminal device, a wireless terminal in industrial control, a terminal in self driving, a terminal in remote medical, a terminal in a smart grid, a terminal in transportation safety, a terminal in a smart city, a terminal in a smart home, a terminal device in a future communication network, or the like. Certainly, the terminal device in this application may alternatively be a chip, a modem, a system on a chip (SoC), or a communication platform that may include a radio frequency RF part or the like mainly responsible for a related communication function in the device.

The terrestrial station device may be a device in a core network (CN) in an existing mobile communication architecture (for example, a 3rd generation partnership project (3GPP) access architecture of a 5G network), a device in a core network in a future mobile communication architecture, a device used for connecting a satellite and a core network, or a relay device used for satellite communication. As a bearer network, the core network provides an interface to a data network, and is configured to provide communication connection, authentication, management, and policy control for UE, bear a data service, and the like. The CN may further include an access and mobility management function (AMF) network element, a session management function (SMF) network element, an authentication server function (AUSF) network element, a policy control function (PCF) node, a user plane function (UPF) network element, and the like. The AMF network element is configured to manage access and mobility of the UE, and is mainly responsible for functions such as UE authentication, UE mobility management, and UE paging.

A network device may include but is not limited to: an evolved NodeB (eNB), a baseband unit (BBU), an access point (AP) in a wireless fidelity (Wi-Fi) system, a wireless relay node, a wireless backhaul node, a transmission point (TP), a transmission reception point (TRP), or the like. The network device may alternatively be a gNB, a TRP, or a TP in a 5G system, or one antenna panel or a group of antenna panels (including a plurality of antenna panels) of a base station in the 5G system. In addition, the network device may alternatively be a network node that forms the gNB or the TP, for example, a BBU. Alternatively, the network device may be a device responsible for a network side function in a device-to-device (D2D) communication system, a machine to machine (M2M) communication system, an internet of things (IoT) communication system, an internet of vehicles communication system, or another communication system.

The network device in embodiments of this application may include a central unit (CU) and/or a distributed unit (DU). It may be understood that the network device is divided into the CU and the DU from the perspective of a logical function. The CU and the DU may be physically separated or deployed together. A plurality of DUs may share one CU. One DU may be connected to a plurality of CUs. The CU and the DU may be connected through an interface, for example, an F1 interface.

The CU and the DU may be obtained through division based on protocol layers of a wireless network. In a possible division manner, the CU is configured to perform functions of a radio resource control (RRC) layer, a service data adaptation protocol (SDAP) layer, and a packet data convergence protocol (PDCP) layer; and the DU is configured to perform functions of a radio link control (RLC) layer, a media access control (MAC) layer, a physical (PHY) layer, and the like.

It may be understood that processing function division of the CU and the DU based on protocol layers is merely an example, and the CU and the DU may be divided in another manner. For example, the CU or the DU may be divided into functions of more protocol layers than those in the foregoing division manner. For example, the CU or the DU may alternatively be divided into some processing functions of protocol layers in the foregoing division manner.

Alternatively, division into functions of the CU or the DU may be performed based on service types or other system requirements. For example, division is performed based on a delay. Functions whose processing time meets a delay requirement are set in the DU for implementation, and functions whose processing time does not meet the delay requirement are set in the CU for implementation.

Alternatively, the CU may also have one or more functions of the core network. One or more CUs may be disposed together or separately. For example, the CUs may be disposed on a network side for ease of centralized management. The DU may have a plurality of radio frequency functions, or the radio frequency functions may be disposed remotely.

The functions of the CU may be implemented by one entity, or may be implemented by different entities. For example, the functions of the CU may be further divided, for example, a control plane (CP) and a user plane (UP) are separated. To be specific, the CU is divided into a control plane (CU-CP) and a CU user plane (CU-UP). The CU-CP may further include a further division architecture. To be specific, the CU-CP is divided into a CU-CP 1 and a CU-CP 2. The CU-CP 1 may include various radio resource management functions, and the CU-CP 2 may include an RRC function and a PDCP-C function (namely, a basic function of control plane signaling at the PDCP layer).

In different systems, the CU (including the CU-CP and the CU-UP) or the DU may also have different names, but a person skilled in the art may understand meanings thereof. For example, in an open radio access network (O-RAN) system, the CU may be referred to as an open CU (O-CU), and the DU may also be referred to as an open DU (O-DU). Alternatively, the CU-CP may also be referred to as an O-CU-CP, and the CU-UP may also be referred to as an O-CU-UP. For ease of description, the CU and the DU are used as an example for description in this application.

The satellite in embodiments of this application may be an LEO satellite, a medium orbit earth satellite (MEO), a geosynchronous orbit (GEO) satellite, or the like, or may be a satellite base station, or may be an orbital receiver machine or a repeater configured to relay information, or may be a network device carried on the satellite, that is, the satellite has some or all functions of the network device. For example, the satellite may be used as a gNB-DU. The satellite may provide a service for a ground terminal device by using a plurality of beams. When the satellite covers a service zone by using a plurality of beams, a service may be provided for the service zone by using different beams in one or more manners of time division, frequency division, and space division, and different beams may also be used in different polarization manners, for example, circular polarization (including left-hand circular polarization and right-hand circular polarization). The satellite may wireless communicate with the terminal device via a broadcast communication signal, a navigation signal, and the like. In addition, the satellite may wirelessly communicate with a terrestrial station device.

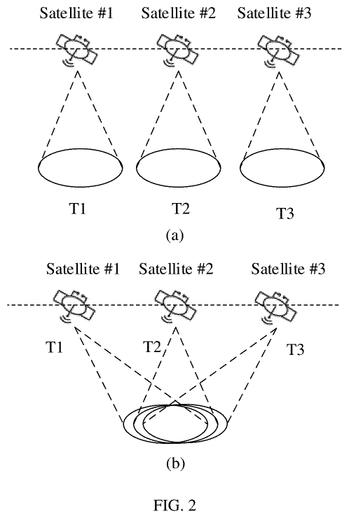

Based on a working mode of a payload (for example, a beam), a satellite communication system may be usually classified into an earth-fixed (earth-fixed or quasi-earth fixed) satellite communication system and an earth-moving (earth-moving) satellite communication system. As shown in (a) in FIG. 2, beam coverage of satellites (for example, a satellite #1, a satellite #2, and a satellite #3) in an earth-moving satellite communication system moves with the satellites in a period of time (for example, a moment T1, a moment T2, and a moment T3). As shown in (b) in FIG. 2, in an earth-fixed satellite communication system, a satellite dynamically adjusts a beam direction, so that a beam approximately covers a same zone on the ground in a period of time.

To facilitate understanding of embodiments of this application, terms that may be involved in this application are described.

### 1. Beam Position

A service zone of a satellite network may be divided into a plurality of small geographical areas based on geographical positions, and each geographical area may be referred to as a beam position. Optionally, the beam position in this application may be alternatively represented as a geographical area, a zone, a service zone, or the like. In addition, the beam position may be represented in different shapes, for example, one or more of a regular hexagon, a pentagon, a circle, an ellipse, and a rectangle.

### 2. Beam Hopping Satellite Communication System

Generally, a single satellite has extremely wide coverage, which may reach thousands of meters or even tens of thousands of kilometers, and a single beam has minimum coverage of dozens of meters or even thousands of meters. Therefore, to support wide coverage, hundreds or even thousands of beams usually need to be configured for a single satellite, which poses a great challenge to a payload of the satellite (especially an LEO satellite). To alleviate a contradiction between a low payload and wide coverage of a single satellite, a beam hopping satellite communication system emerges. Specifically, in the beam hopping satellite communication system, only a few beams (for example, several or dozens of beams) are configured for a single satellite, and a beam serves a coverage zone of the single satellite in a time division manner.

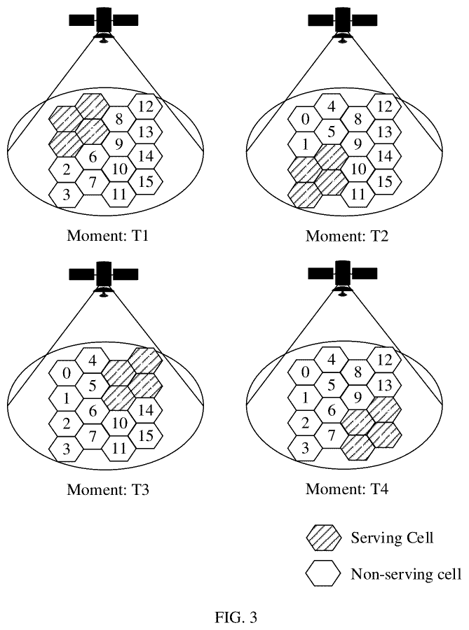

FIG. 3 is a diagram of a beam hopping satellite communication system. As shown in FIG. 3, a satellite forms four beams at a moment to cover zones (namely, a beam position) corresponding to the beams. For example, four beams 0, 1, 4, and 5 are formed at a moment T1, and four beams 2, 3, 6, and 7 are formed at a moment T2. All zones (namely, zones corresponding to 16 beams) covered by a single satellite are served in a time division manner at the moment T1, the moment T2, a moment T3, and a moment T4.

### 3. Mobility Management

In a beam hopping satellite communication system, movement of a satellite node may cause group handover (UE in a connected state) or group reselection (UE in an idle state or an in-active state) of UE in a beam position of a zone.

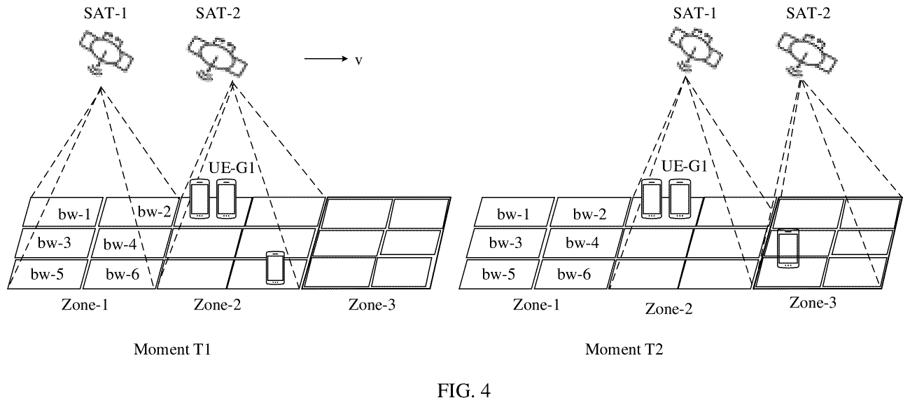

FIG. 4 is a diagram of group handover. As shown in FIG. 4, at a moment T1, one or more beams of a satellite SAT-2 serve a UE group (UE-Group) 1 in a single beam position of a zone (Zone)-2, which is briefly denoted as UE-G1 (the UE-G1 includes at least one UE). At a moment T2, the satellite SAT-2 moves, the satellite SAT-2 cannot serve the UE-G1, and one or more beams of a satellite SAT-1 replace the satellite SAT-2 to serve the UE-G1. Therefore, group handover may occur on the UE-G1. In addition, because a satellite moves at a high speed, for example, about 7.5 km/s, a frequency of group handover of a UE group within coverage of the satellite is about once/seconds to dozens of seconds. In other words, in the beam hopping satellite communication system, group handover or group reselection mainly triggered by movement of a satellite node becomes normal. Mobility management of a UE group within coverage of a single satellite may cause huge inter-satellite or inter-cell signaling overheads (for example, inter-satellite overheads of a single time of handover are about 23 Kbits, and total overheads can reach several Gbps or even dozens of Gbps).

Mobility management mainly includes cell handover, cell reselection, registration update, tracking zone update, and the like. Cell handover is used as an example. A handover procedure in a terrestrial network mainly includes the following steps.
(1) Cell handover measurement: A network side sends, to the UE, measurement configurations corresponding to a plurality of cells (including a serving cell and a neighboring cell). The UE measures signal quality of the cells based on the measurement configurations, for example, reference signal received power (RSRP) and reference signal received quality (RSRQ).
(2) Measurement result reporting: The UE reports a measurement result to the network side. A reporting manner may be periodic reporting, event-triggered reporting, or the like. In the event-triggered reporting, a reporting condition is generally configured as follows: Signal quality of the serving cell is lower than a preset threshold and/or signal quality of the neighboring cell is higher than a preset threshold.
(3) Handover decision: The network side selects an appropriate neighboring cell based on the reported measurement result, and exchanges information such as UE handover-related context information, admission control, and reserved resources.
(4) Handover execution: The UE receives handover-related control information from the serving cell and completes an access procedure in a target cell.

A random access preamble required by the UE during handover is a dedicated preamble, which is different from a contention-based random access preamble during initial access. In addition, a configuration supported by a time domain periodicity of a random access channel (random access channel, RACH) during handover is 10/20/40/80/160 ms, which is the same as a configuration of a RACH periodicity during initial access.

For cell reselection, the network side generally delivers, to the UE in a broadcast manner, parameters such as a measurement configuration related to the neighboring cell. The UE compares a measurement value (like RSRQ and RSRP) of the UE with the parameter (like a reselection threshold) and the like delivered by the network, and autonomously reselects to a target neighboring cell after a condition is satisfied. It should be noted that, because a near-far effect in an NTN is not significant (that is, impact of distances between the UE and different satellites on signal quality is not significant), efficiency of handover/reselection triggered by signal quality alone is low. Therefore, a position-assisted handover/reselection enhancement technology is considered for the NR/NTN, for example, mobility management in an NTN scenario is implemented based on a plurality of manners such as a time/a timer, UE position information (for example, a distance between the UE and a reference point of a source cell is greater than a preset threshold, and a distance between the UE and a reference point of a target cell is less than a preset threshold), a combination of UE position information and a timer, and a combination of UE position information and signal quality.

In existing NR and NTN handover/reselection solutions, handover/reselection is triggered mainly by UE mobility. In an NTN network (especially in an LEO scenario), group handover triggered mainly by network (for example, a satellite) mobility becomes normal. Group handover/group reselection triggered mainly by network mobility needs to exchange a large amount of information, and signaling overheads are high.

For ease of understanding of embodiments of this application, the following several points are described.

First, in embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

Second, “first”, “second”, and various numeric numbers (for example, “#1” and “#2”) shown in this application are merely intended to distinguish between objects for ease of description, but not to limit the scope of embodiments of this application. For example, “first”, “second”, and various numeric numbers are used to distinguish between different terminal devices, but are not used to describe a particular order or sequence. It should be understood that the objects described in such a way are interchangeable in an appropriate circumstance, so that a solution other than the solutions in embodiments of this application can be described.

Third, in embodiments of this application, “of (of)”, “corresponding or relevant (corresponding, relevant)”, “corresponding (corresponding)”, and “associate (associate)” may be interchangeably used sometimes. It should be noted that meanings expressed by the terms are consistent when differences are not emphasized.

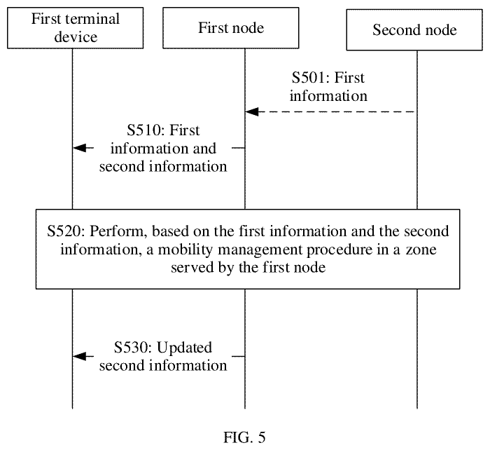

FIG. 5 is a schematic flowchart of a communication method 500 according to this application. The method may include the following several steps.

S510: A first node sends first information and second information to a first terminal device. Correspondingly, the first terminal device receives the first information and the second information from the first node.

The first information may include common information for performing mobility management on at least one terminal device in at least one zone corresponding to a second node, and the first information may also be referred to as common part information. The second information may include dedicated information for performing mobility management on the first terminal device, and the second information may also be referred to as dedicated part information. The at least one zone includes a zone served by the first node.

The first terminal device may be any terminal device within a service range of the first node. It may be understood that the first terminal device is also located in a service range of the second node. In other words, the at least one terminal device includes the first terminal device. Optionally, the service range of the second node may further include another terminal device.

For example, this mobility management includes cell handover or cell reselection.

In other words, the common part information are for a terminal device, in the at least one zone, on which handover and/or reselection are/is to be performed. In a scenario in which cell handover/cell reselection is triggered mainly by network mobility, a terminal device, in one or more zones, on which handover and/or reselection are/is to be performed is usually a group of terminal devices, which is briefly referred to as a terminal device group, a UE group, or the like below. In other words, the common part information may include common information of the terminal device group, in the at least one zone, on which handover and/or reselection are/is to be performed, and the dedicated part information includes dedicated information of each terminal device in the terminal device group, in the at least one zone, on which handover and/or reselection are/is to be performed.

For example, the first information may include at least one of the following information:
an identity ID(s) of an interface (F1) application protocol (AP) between the second node and the at least one node, a common measurement configuration (Common-MeasConfig), a common cell group configuration (CellGroupConfig), a common radio bearer configuration (Common-RadioBearerConfig), and a common reconfiguration with synchronization (Common reconfigurationWithSync). The at least one node includes the first node.

The common measurement configuration may include a periodicity and duration of a synchronization signal and physical broad channel (PBCH) block (SSB) measurement timing configuration (SMTC). For example, a maximum periodicity of the SMTC is 160 ms. The common measurement configuration may further include information such as a reference position of the second node and a measurement priority of the at least one zone corresponding to the second node. The common cell group configuration may be used to configure a master cell group or a secondary cell group. The common radio bearer configuration may be used to configure configurations such as a common signaling bearer (SRB) (for example, an SRB 0, an SRB 1, and an SRB 2) and a data bearer. The common reconfiguration with synchronization may include a time domain configuration of a random access channel occasion (RO) corresponding to handover, for example, a physical random access channel (PRACH) configuration index (prach-configurationIndex), a preamble, and a frequency domain msg1-FDM factor (indicating a quantity of ROs configured in frequency domain, namely, a quantity of ROs included in a same time domain resource), and a common validity period or a timer of the F1-AP.

The second information may include at least one of the following information:
a dedicated measurement configuration (Dedicated-MeasConfig) of the first terminal device, a dedicated cell group configuration (Dedicated-CellGroupConfig) of the first terminal device, a dedicated radio bearer configuration (RadioBearerConfig) of the first terminal device, and a dedicated reconfiguration with synchronization (Dedicated-ReconfigurationWithSync) of the first terminal device.

For example, the Dedicated-MeasConfig is used to configure a plurality of SMTCs, along with an SMTC periodicity extension factor. The Dedicated-MeasConfig may include an SMTC-offset, to resolve a problem of a delay difference between measurements of different satellites/cells. The Dedicated-MeasConfig may further include ephemeris information of different neighboring satellites and ephemeris information at different moments. The Dedicated-ReconfigurationWithSync may include extension factors and quantities of RO consecutive frames of a plurality of ROs, to adapt to non-uniform access requirements of different cells or beam positions; and an offset of the common validity period of the F1-AP. The Common-RadioBearerConfig may be used to configure a dedicated signaling bearer (for example, an SRB 2 and an SRB 3 that are dedicated to the first terminal device).

In a possible implementation, the first information may be determined by the second node, and the second information may be determined by the first node. The second information is related to a zone (a serving cell of the terminal device, or a cell or a beam position in which the terminal device is currently located) in which the first terminal device is currently located. For example, for cells on different frequencies, the second information of the terminal device may be different. The “determine” may be replaced with “generate”.

The first node described above may be a node in an NTN communication scenario. The first node may be configured to bear some or all functions of a gNB-DU. The second node may be a node or a terrestrial station in an NTN communication scenario. The second node may be configured to bear some or all functions of a gNB-CU. A satellite communication scenario is used as an example. The first node may be a first satellite, and the second node is a second satellite or a terrestrial station corresponding to the first satellite.

In a possible scenario, the second node corresponds to at least one geographical area, or each geographical area may be identified by a second node serving the geographical area. The second node corresponds to at least one node. For example, that the second node corresponds to the at least one node may be understood as follows: A geographical area corresponding to the second node may be served by the at least one node, that is, the geographical area includes at least one zone (for example, a cell or a beam position) corresponding to each of the at least one node.

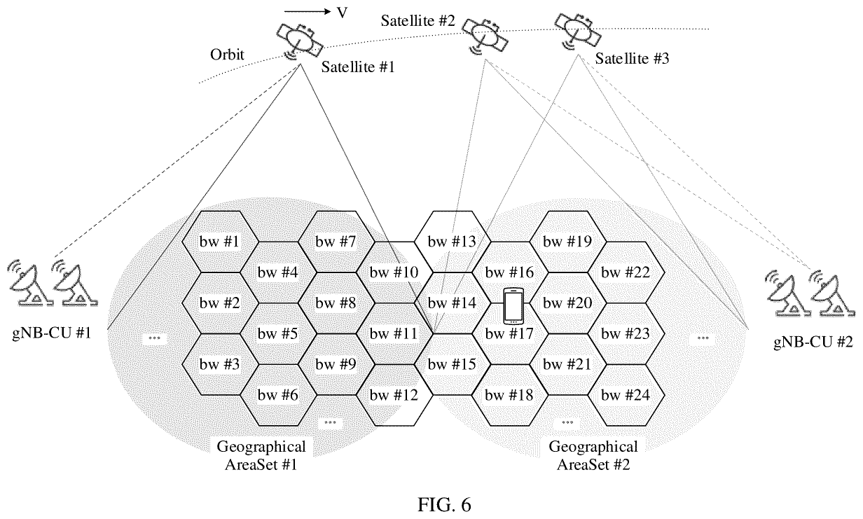

FIG. 6 is a diagram of service ranges of a first node and a second node.

As shown in FIG. 6, the second node includes a gNB-CU #1 and a gNB-CU #2. A geographical area (for example, a GeographicalAreaSet #1) served by the gNB-CU #1 includes at least one beam position (for example, a beam position bw #1 to a beam position bw #12), and the at least one beam position is served by a satellite #1 (an example of the at least one node corresponding to the second node). A geographical area (for example, a GeographicalAreaSet #2) served by the gNB-CU #2 includes at least one beam position (for example, a beam position bw #13 to a beam position bw #25), and the at least one beam position may be served by a satellite #2 and a satellite #3 (examples of the at least one node corresponding to the second node).

S520: The first terminal device performs, based on the first information and the second information, a mobility management procedure in the zone served by the first node.

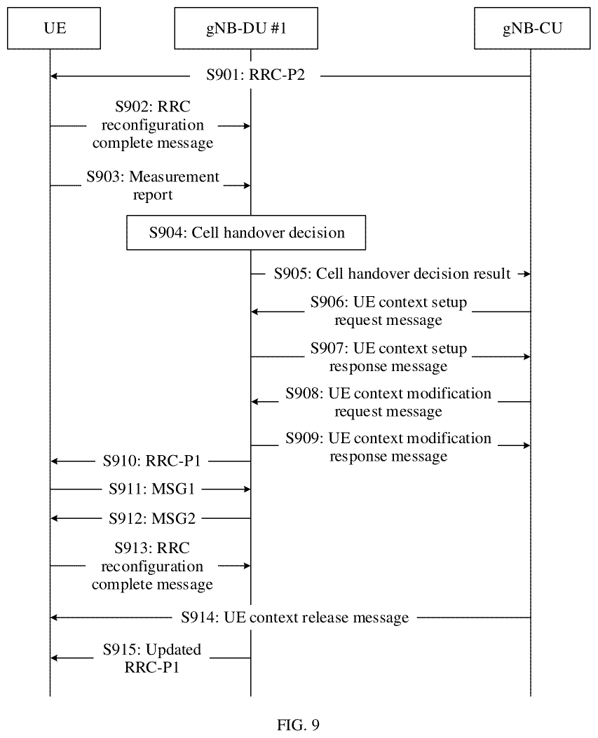

For example, when the first node or the first terminal device moves, a mobility procedure of the first terminal device in the zone served by the first node may be triggered. The first terminal device measures a candidate zone based on the first information and the second information to obtain a measurement report. The candidate zone may be the zone served by the first node. The measurement report may be used to represent signal quality of the candidate zone. The first terminal device sends the measurement report to the first node, so that the first node determines to perform the mobility management procedure. For a specific process in which the first terminal device and the first node perform the mobility procedure, refer to descriptions in FIG. 9.

S530: The first node sends updated second information to the first terminal device.

The updated second information corresponds to a zone in which the terminal device is located after handover.

For example, the second information includes the Dedicated-ReconfigurationWithSync. Extension factors and the quantities of RO consecutive frames of a plurality of ROs included in the Dedicated-ReconfigurationWithSync corresponding to the zone in which the terminal device is located after handover may be different from the extension factors and the quantity of consecutive RO frames of the plurality of ROs included in the Dedicated-ReconfigurationWithSync corresponding to the zone in which the terminal device is located before handover.

To be specific, when the first terminal device moves from the zone to another zone that are served by the first node in the mobility management procedure, the first node may send only the updated second information to the first terminal device. In other words, the first node may send the updated second information to the first terminal device, and does not need to send the first information, to reduce signaling overheads in the mobility management procedure.

It should be understood that the foregoing uses an example in which the mobility management procedure includes cell handover to describe the solution of this application. The mobility management procedure in embodiments of this application may alternatively be cell reselection. This is not limited.

Based on the foregoing solution, information about a to-be-handed-over terminal device and/or a to-be-reselected terminal device is divided into common part information and dedicated part information, and only the dedicated part information of the terminal device is updated in a mobility management procedure in which the terminal device is handed over/reselected from a zone to another zone that are of one node, so that signaling overheads in the mobility management process of the terminal device can be reduced.

Optionally, the method further includes the following content.

S501: The second node sends the first information to the first node. Correspondingly, the first node receives the first information from the second node.

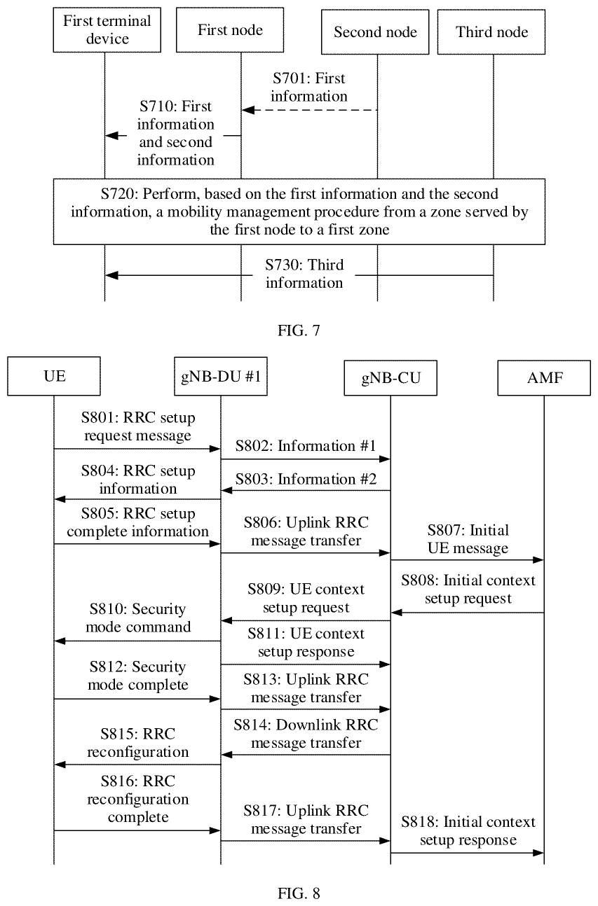

For example, in an initial access procedure of the first terminal device, the second node sends the first information to the first node. For details of the initial access procedure, refer to descriptions in FIG. 8.

FIG. 7 is a schematic flowchart of a communication method 700 according to this application. The method may be applied to a procedure in which a terminal device performs cell handover/cell reselection between different nodes (for example, the satellite #2 and the satellite #3 in FIG. 6) corresponding to a second node (for example, the gNB-CU #2 in FIG. 6). That different nodes corresponding to the second node may be understood as that a geographical area served by the second node includes zones served by the different nodes. The method may include the following several steps.

S710: A first node sends first information and second information to a first terminal device. Correspondingly, the first terminal device receives the first information and the second information from the first node.

For the first node, the second node, the first terminal device, the first information, and the second information, refer to the descriptions in S510.

S720: The first terminal device performs, based on the first information and the second information, a mobility management procedure from a zone served by the first node to a first zone.

The first zone is a zone served by a third node. The third node may be one of at least one node corresponding to the second node. For example, the third node is a third satellite.

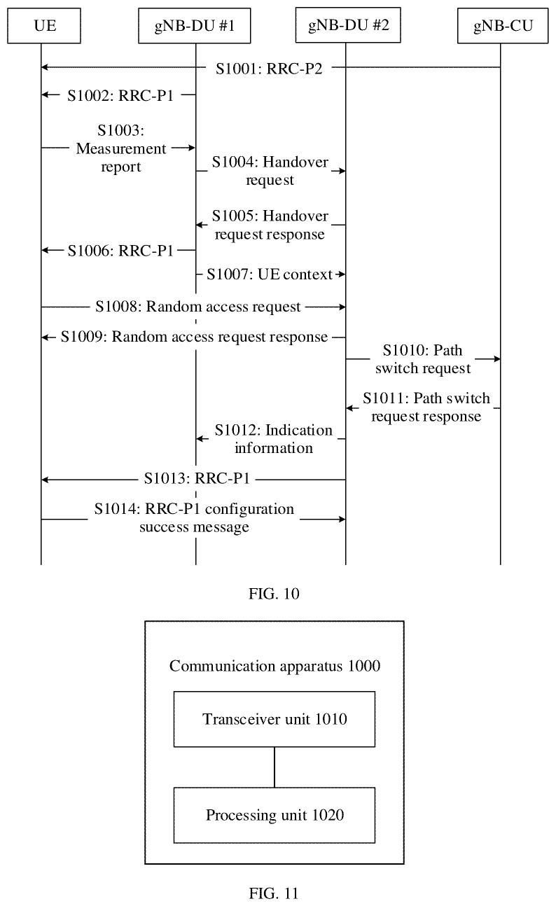

For example, when the first node or the first terminal device moves, a mobility procedure of the first terminal device from the zone served by the first node to the first zone may be triggered. The first terminal device measures a candidate zone based on the first information and the second information to obtain a measurement report. The candidate zone may include the zone served by the first node and the first zone. The measurement report may be used to represent signal quality of the candidate zone. The first terminal device sends the measurement report to the first node, so that the first node determines to perform the mobility management procedure. For a specific process in which the first terminal device, the first node, and the third node perform the mobility procedure, refer to descriptions in FIG. 10.

S730: The third node sends third information to the first terminal device. Correspondingly, the first terminal device receives the third information from the third node.

The third information includes dedicated information for performing mobility management on the first terminal device. The third information corresponds to the first zone, and the third information may be determined by the third node.

For example, the third information may include a dedicated measurement configuration (Dedicated-MeasConfig) of the first terminal device, a dedicated cell group configuration (Dedicated-CellGroupConfig) of the first terminal device, a dedicated radio bearer configuration (RadioBearerConfig) of the first terminal device, and a dedicated reconfiguration with synchronization (Dedicated-ReconfigurationWithSync) of the first terminal device.

For example, the third information includes the Dedicated-MeasConfig. That the third information corresponds to the third node may be understood as follows: An SMTC periodicity extension factor included in the Dedicated-MeasConfigSMTC corresponding to the third node may be different from an SMTC periodicity extension factor included in Dedicated-MeasConfigSMTC corresponding to the first node.

For example, a serving cell of the terminal device is a cell (for example, a cell #1) of a satellite #1 (an example of the first node), and Dedicated-MeasConfig for the cell #1 may include ephemeris information of the satellite #1. If the terminal device is handed over from the cell #1 to a cell #2 (a cell of a satellite #2), Dedicated-MeasConfig for the cell #2 may include ephemeris information of the satellite #2 (an example of the third node). Correspondingly, SMTC-offsets corresponding to cells are also different. For example, an SMTC-offset-1 of the cell #1 is 1 ms, and an SMTC-offset-2 of the cell l #2 is 1.2 ms.

To be specific, when the mobility management procedure of the first terminal device from the zone served by the first node to the first zone (an example of at least one zone served by the third node) is performed, the third node may send only dedicated part information of the first terminal device to the first terminal device, that is, the third node may send the dedicated part information of the first terminal device to the first terminal device, and does not need to send common part information.

In addition, common part information and dedicated part information of different networks may be configured in a delta manner. Specifically, one piece of reference (reference) common part information (denoted as a Reference RRC-P1) and/or reference dedicated part information (denoted as a Reference RRC-P2), and one or more delta configurations relative to the reference part information may be configured for the terminal device, for example, a delta configuration corresponding to the reference common part information is denoted as a delta RRC-P1, and a delta configuration corresponding to the reference dedicated part information is denoted as a delta RRC-P2. When the network device (for example, the first node or the third node) needs to configure the common part information or the dedicated part information for the terminal device (for example, the first terminal device), different Reference RRCs and/or delta RRCs may be indicated.

Based on the foregoing solution, information about a to-be-handed-over terminal device and/or a to-be-reselected terminal device is divided into common part information and dedicated part information, and only the dedicated part information of the terminal device is updated in a mobility management procedure of the terminal device from a node to another node, so that signaling overheads in the mobility management process of the terminal device can be reduced.

Optionally, the method further includes the following content.

S701: The second node sends the first information to the first node. Correspondingly, the first node receives the first information from the second node.

For details, refer to the descriptions in S501.

FIG. 8 shows an initial access method according to this application. The method may include the following several steps.

S801: UE sends an RRC setup request (RRC Setup Request) message to a gNB-DU #1. Correspondingly, the gNB-DU receives the RRC setup request message from the UE.

The RRC setup request message includes position information of the UE.

For example, the position information of the UE may be determined by using global navigation satellite system (global navigation satellite system, GNSS) information of the UE, or the position information of the UE includes information about a geographical position at which the UE is located, for example, information about a beam in which the UE is located, beam identity information, beam position information, beam position-related identity information, or longitude and latitude information.

S802: The gNB-DU #1 sends information #1 to a gNB-CU. Correspondingly, the gNB-CU receives the information #1 from the gNB-DU #1.

The information #1 includes RRC-P1 information (an example of second information) of the UE.

Optionally, the RRC-P1 information includes an ID (a dedicated ID) used by the UE within a service range of the gNB-CU, and the dedicated ID may include geographical position information. The dedicated ID information is unique within the service range of the gNB-CU.

Optionally, the information #1 further includes underlying configuration information, and the underlying configuration information includes configuration information of a physical layer and/or a media access control (MAC) layer.

For example, the gNB-DU #1 sends the information #1 to the gNB-CU via an INITIAL UL RRC MESSAGE TRANSFER message.

S803: The gNB-CU sends information #2 to the gNB-DU #1. Correspondingly, the gNB-DU #1 receives the information #2 from the gNB-CU.

The information #2 may include RRC-P2 information (an example of first information) of the UE. Optionally, the information #2 may include at least one of information related to an F1-AP ID and interface information between the gNB-CU and the gNB-DU #1.

The information related to the F1-AP ID may include information related to a validity period/timer of the F1-AP ID, or an F1-AP ID update mechanism triggered by a position change of the gNB-DU #1.

For example, the gNB-CU sends the information #2 to the gNB-CU via a downlink RRC message transfer (DL RRC MESSAGE TRANSFER) message.

S804: The gNB-DU #1 sends RRC setup (RRCSetup) information to the UE. Correspondingly, the UE receives the RRC setup (RRCSetup) information from the gNB-DU #1.

For example, the RRCSetup information may include dedicated part information and common part information of the UE that are included in the information #1 and the information #2.

S805: The UE sends an RRC connection setup complete (RRCSetupComplete) message to the gNB-DU #1. Correspondingly, the gNB-DU #1 receives the RRC connection setup complete (RRCSetupComplete) message from the UE.

For example, after RRC connection is set up, the UE sends the RRC connection setup complete message to the gNB-DU #1.

S806: The gNB-DU #1 sends an uplink RRC message transfer (UL RRC MESSAGE TRANSFER) message to the gNB-CU. Correspondingly, the gNB-CU receives the UL RRC MESSAGE TRANSFER message from the gNB-DU #1.

The UL RRC MESSAGE TRANSFER message may include the RRC connection setup complete message.

S807: The gNB-CU sends an INITIAL UE MESSAGE message to an AMF. Correspondingly, the AMF receives the INITIAL UE MESSAGE message from the gNB-CU.

The INITIAL UE MESSAGE may include the position information of the UE.

S808: The AMF sends an initial context setup request (INITIAL CONTEXT SETUP REQUEST) message of the UE to the gNB-CU. Correspondingly, the gNB-CU receives the INITIAL CONTEXT SETUP REQUEST message from the AMF.

S809: The gNB-CU sends a UE context setup request (CONTEXT SETUP REQUEST) message to the gNB-DU #1. Correspondingly, the gNB-DU #1 receives the UE CONTEXT SETUP REQUEST message from the gNB-CU.

The UE context setup request message may be used to request to set up an SRB bearer and a DRB bearer.

S810: The gNB-DU #1 sends a SecurityModeCommand message to the UE.

The SecurityModeCommand message may include a security algorithm configuration (securityAlgorithmConfig).

S811: The gNB-DU #1 sends a UE context setup response (UE CONTEXT SETUP RESPONSE) message to the gNB-CU.

S812: The UE sends a security mode complete (SecurityModeComplete) message to the gNB-DU #1.

The SecurityModeComplete message is used to confirm that the security mode command is completed.

S813: The gNB-DU #1 sends a UL RRC MESSAGE TRANSFER message to the gNB-CU.

The gNB-DU #1 may send the SecurityModeComplete message to the gNB-CU via the UL RRC MESSAGE TRANSFER message.

The UL RRC MESSAGE TRANSFER message may further include the RRC-P1 (an example of the second information) of the UE.

S814: The gNB-CU sends a DL RRC MESSAGE TRANSFER message to the gNB-DU #1.

The DL RRC MESSAGE TRANSFER message includes an RRC reconfiguration (RRCReconfiguration) message, and the RRCReconfiguration message includes the RRC-P2 (an example of the first information). The RRC-P2 may include a common measurement configuration, a common cell group configuration, a common radio bearer configuration, and a common reconfiguration with synchronization in a group/geographical area in which the UE is located.

For example, after receiving the RRC-P1 from the gNB-DU #1, the gNB-CU sends the RRC-P2 to the gNB-DU #1 via the DL RRC MESSAGE TRANSFER message.

S815: The gNB-DU #1 sends the RRCReconfiguration message to the UE.

The RRCReconfiguration message may include the RRC-P1 and the RRC-P2.

S816: The UE sends an RRC reconfiguration complete (RRCReconfigurationComplete) message to the gNB-DU #1.

S817: The gNB-DU #1 sends a UL RRC MESSAGE TRANSFER message to the gNB-CU. Correspondingly, the gNB-CU receives the UL RRC MESSAGE TRANSFER message from the gNB-DU #1.

For example, the gNB-DU #1 encapsulates an RRC message in the UL RRC MESSAGE TRANSFER and sends the UL RRC MESSAGE TRANSFER to the gNB-CU. The RRC message may be the RRCReconfigurationComplete message.

S818: The gNB-CU sends an INITIAL CONTEXT SETUP RESPONSE message to the AMF. Correspondingly, the AMF receives the INITIAL CONTEXT SETUP RESPONSE message from the gNB-CU.

Based on the foregoing initial procedure solution, the gNB-DU #1 (an example of a first node) may receive the first information from the gNB-CU (an example of a second node), so that the gNB-DU #1 sends the first information and the second information to the UE (an example of a first terminal device).

With reference to FIG. 9 and FIG. 10, the following describes in detail the communication method 500 and method 700 provided in this application by using an example in which a terminal device is handed over between different zones of a same node or different nodes. It may be understood that embodiments shown in FIG. 9 and FIG. 10 are respectively based on embodiments shown in FIG. 5 and FIG. 7, to describe the communication method provided in this application. Embodiments may be mutually referenced. In addition, in embodiments shown in FIG. 9 and FIG. 10, UE is used as a first terminal device, a gNB-DU #1 is used as a first node, a gNB-CU is used as a second node, and a gNB-DU #3 is used as a third node for description.

FIG. 9 is a schematic flowchart of a communication method 900 according to this application. The method may include the following several steps.

S901: A gNB-CU sends RRC-P2 information (an example of first information) to UE. Correspondingly, the UE receives the RRC-P2 information from the gNB-CU.

For example, the gNB-CU sends the RRC-P2 information to the UE via an RRC reconfiguration (RRCReconfiguration) message, that is, the RRC-P2 information may be included in the RRC reconfiguration message. The RRC-P2 information may include common measurement configuration information.

The measurement configuration information includes information required for measuring a candidate cell. For example, the measurement configuration information may include a measurement object (measurement object) and a measurement reporting configuration (reporting configuration). Optionally, the measurement configuration information may further include information such as a measurement identity (measurement identity), a quantity configuration (quantity configuration), and a measurement gap (measurement gap).

The measurement target is used to identify a candidate cell that needs to be measured by the UE, namely, a to-be-measured cell. The to-be-measured cell may also be referred to as a target cell. The measurement object may include an identity of one or more candidate cells. For example, if the measurement object includes identities of a Cell 1 and a Cell 2, it indicates that the measurement object of the UE is the Cell 1 and the Cell 2, that is, the UE needs to measure signal strength of the Cell 1 and the Cell 2.

The measurement reporting configuration information may include a reporting criterion (reporting criterion). In other words, when a measurement result of a candidate cell meets the reporting criterion, the UE may report a measurement report of the candidate cell. For example, the reporting criterion may be that signal strength of the candidate cell is greater than or equal to a threshold.

Optionally, the measurement reporting configuration information may further include measurement parameter information, and the measurement parameter information indicates a measurement result of a parameter that needs to be included in the measurement report.

The measurement identity may be used to associate one measurement object with one piece of measurement reporting configuration information. A plurality of measurement identities are configured, so that a plurality of measurement objects can be associated with one measurement reporting configuration, or a plurality of measurement reporting configurations can be associated with one measurement object.

The quantity configuration may indicate a quantity of cells included by the UE in the measurement report. For example, the quantity configuration indicates that the UE includes measurement results of two cells in the measurement report. In this case, the UE may include measurement results of two candidate cells with the highest signal strength in the measurement report.

The measurement gap may indicate a periodicity of performing measurement by the UE. For example, if the measurement gap indicates that the periodicity of performing measurement by the UE is 30 s, the UE measures a signal of the candidate cell every 30 s.

S902: The UE sends an RRC reconfiguration complete (RRCReconfigurationComplete) message to the gNB-CU.

For example, the UE receives the RRC reconfiguration message from the gNB-CU, and the UE sends the RRC reconfiguration complete message to the gNB-CU after completing RRC reconfiguration.

S903: The UE sends a neighboring cell measurement report to a gNodeB-DU #1.

For example, the UE measures the candidate cell based on the measurement configuration information in S901, and sends a measurement report of the target cell to the gNodeB-DU based on the measurement reporting configuration information. The measurement report may include a PCI of the target cell.

The gNodeB-DU #1 is a gNodeB-DU serving the UE, that is, the UE is located in a cell served by the gNodeB-DU #1. The UE sends the neighboring cell measurement report to the gNodeB-DU #1, that is, the message does not need to be transmitted to the gNB-CU.

S904: The gNodeB-DU #1 determines whether to perform cell handover on the UE.

For example, after receiving the measurement report from the UE, the gNodeB-DU #1 determines, based on the measurement report, whether to perform cell handover on the UE.

For example, the gNodeB-DU #1 receives a measurement report for the Cell 1 (an example of the target cell) from the UE. The measurement report includes a measurement result of the signal strength of the Cell 1. The gNodeB-DU #1 determines whether the measurement result of the Cell 1 meets a handover condition. The handover condition is a condition used to determine whether the UE can be handed over from a serving cell to the candidate cell, and the handover condition is, for example, that the signal strength of the candidate cell is greater than a specified threshold. If the measurement result of the Cell 1 meets the handover condition, the gNodeB-DU #1 may determine to perform cell handover on the UE, or hand over the UE to the Cell 1, or hand over the UE from the serving cell to the Cell 1.

When the gNodeB-DU #1 determines, based on the measurement report, to perform cell handover on the UE, the gNodeB-DU #1 determines, based on the PCI of the target cell included in the measurement report, whether the target cell for handover and the serving cell belong to a gNodeB-DU. If the target cell and the serving cell belong to the same gNodeB-DU, an intra-gNodeB-DU handover procedure is started. If the target cell and the serving cell do not belong to the same gNodeB-DU, an inter-gNodeB-DU handover procedure is started.

S905: The gNodeB-DU #1 sends a cell handover decision result to the gNodeB-CU.

For example, the cell handover decision result may be handing over from a cell (the serving cell) served by the gNodeB-DU #1 to another cell (the target cell).

S906: The gNodeB-CU sends a UE context setup request (UE CONTEXT SETUP REQUEST) message to the gNodeB-DU #1. Correspondingly, the gNodeB-DU receives the UE CONTEXT SETUP REQUEST message from the gNodeB-CU.

The UE CONTEXT SETUP REQUEST message is used to apply for a user resource for the target cell.

S907: The gNodeB-DU #1 sends a UE context setup response (UE CONTEXT SETUP RESPONSE) message to the gNodeB-CU. Correspondingly, the gNodeB-CU receives the UE CONTEXT SETUP RESPONSE message from the gNodeB-DU #1.

For example, after the resource is successfully allocated, the gNodeB-DU #1 sends the UE CONTEXT SETUP RESPONSE message to the gNodeB-CU.

S908: The gNodeB-CU sends a UE context modification request (UE CONTEXT MODIFICATION REQUEST) message to the gNodeB-DU #1. Correspondingly, the gNodeB-DU #1 receives the UE CONTEXT MODIFICATION REQUEST message from the gNodeB-CU.

The UE CONTEXT MODIFICATION REQUEST is used to indicate the gNodeB-DU to stop scheduling a layer 2 (layer 2, L2) of a source cell (the serving cell).

S909: The gNodeB-DU #1 sends a UE context modification response (UE CONTEXT MODIFICATION RESPONSE) message to the gNodeB-CU. Correspondingly, the gNodeB-CU receives the UE CONTEXT MODIFICATION RESPONSE message sent by the gNodeB-DU #1.

S910: The gNodeB-CU sends RRC-P1 information (an example of the second information) to the UE.

For example, the gNodeB-CU sends the RRC-P1 information to the UE via an RRCReconfiguration message.

Optionally, the RRCReconfiguration further includes a target frequency for handover, a PCI, and a cell radio network temporary identity (cell radio network temporary identity, CRNTI) and a dedicated preamble configured for the UE.

S911: The UE initiates a non-contention-based random access MSG1 message in the target cell.

For example, the MSG1 includes the dedicated preamble.

S912: The gNodeB-DU #1 sends a MSG2 message to the UE.

S913: The UE sends an RRC reconfiguration complete (RRCReconfigurationComplete) message to the gNodeB-CU.

For example, the RRCReconfigurationComplete is used to indicate the UE to access the target cell.

S914: The gNodeB-CU sends a UE context release command (UE CONTEXT RELEASE COMMAND) message to the gNodeB-DU #1.

For example, after receiving the message, the gNodeB-DU #1 releases the UE in the source cell.

S915: After being handed over to the target cell, the gNodeB-DU #1 sends the updated RRC-P1 message to the UE via the RRCReconfiguration.

For example, the updated RRC-P1 may include measurement configuration information of the target cell. For details, refer to the descriptions in S510.

FIG. 10 is a schematic flowchart of a communication method 1000 according to this application. The method may include the following several steps.

S1001: A gNB-CU sends RRC-P2 information (an example of first information) to UE. Correspondingly, the UE receives RRC-P2 from the gNB-CU.

For example, the gNB-CU sends the RRC-P2 to the UE through a gNB-CU #1. For the RRC-P2, refer to the descriptions in S901.

S1002: The gNB-DU #1 sends RRC-P1 information (an example of second information) to the UE. Correspondingly, the UE receives the RRC-P1 information from the gNB-DU #1.

The RRC-P1 may include measurement configuration information. The measurement configuration information may include one or more of the following information: a broadcast signal (based on an SSB) measurement-related measurement configuration, for example, an SMTC periodicity, SMTC duration, and an SMTC offset of a serving cell and a neighboring cell, a measurement priority, a reference point position and a distance threshold of the serving cell and the neighboring cell, a serving time, and the like.

S1003: The UE sends a neighboring cell measurement report to the gNB-DU #1. Correspondingly, the gNB-DU #1 receives the neighboring cell measurement report from the UE.

For this step, refer to the descriptions in S903.

S1004: The gNB-DU #1 sends a handover request to a gNB-DU #2. Correspondingly, the gNB-DU #2 receives the handover request from the gNB-DU #1.

For example, when the gNB-DU #1 determines, based on the neighboring cell measurement report, that the UE meets a handover condition, and a target cell for handover is a cell served by the gNB-DU #2, the gNB-DU #1 sends the handover request to the gNB-DU #2.

S1005: The gNB-DU #2 sends a handover request response message to the gNB-DU #1. Correspondingly, the gNB-DU #1 receives the handover request response message from the gNB-DU #2.

S1006: The gNB-DU #1 sends RRC-P1 information to the UE. Correspondingly, the UE receives the RRC-P1 information from the gNB-DU #1.

The RRC-P1 information may indicate a subsequent handover-related resource and a conditional handover (CHO) trigger condition. The trigger condition is, for example, that satellite signal quality is greater than or equal to a preset threshold.

S1007: The gNB-DU #1 and the gNB-DU #2 exchange context information of the UE.

For example, the gNB-DU #1 and the gNB-DU #2 exchange the context information of the UE through an inter-satellite link (ISL).

S1008: The UE initiates a random access request to the gNB-DU #2. Correspondingly, the gNB-DU #2 receives the random access request from the UE.

S1009: The gNB-DU #2 sends a random access response message to the UE. Correspondingly, the UE receives the random access response message from the gNB-DU #2.

S1010: The gNB-DU #2 sends a path switch request (path switch request) message to the gNB-CU. The gNB-CU receives the path switch request message from the gNB-DU #2.

For example, the path switch request message is used to request to switch a user plane path of the UE.

S1011: The gNB-CU returns a path switch request response message to the gNB-DU #2. The gNB-DU #2 receives the path switch request response message from the gNB-CU.

S1012: The gNB-DU #2 sends indication information to the gNB-DU #1, where the indication information indicates to release the context information of the UE. Correspondingly, the gNB-DU #1 receives the indication information from the gNB-DU #2.

S1013: The gNB-DU #2 sends RRC-P1 information (an example of third information) to the UE. Correspondingly, the UE receives the RRC-P1 information from the gNB-DU #2.

For the third information, refer to the descriptions in S720.

S1014: The UE returns an RRC-P1 configuration success response to the gNB-DU #2. Correspondingly, the gNB-DU #2 receives the RRC-P1 configuration success response from the UE.

The foregoing describes the methods in embodiments of this application in detail with reference to FIG. 5 to FIG. 10. The following describes apparatuses in embodiments of this application in detail with reference to FIG. 11 to FIG. 13. It should be noted that the apparatuses shown in FIG. 11 to FIG. 13 may implement the steps in the foregoing methods.

FIG. 11 is a block diagram of a communication apparatus 1000 according to an embodiment of this application. As shown in FIG. 11, the communication apparatus 1000 may include a transceiver unit 1010 and a processing unit 1020.

In a possible implementation, the communication apparatus 1000 may be the first node in the foregoing method embodiments, or may be a chip configured to implement a function of the first node in the foregoing method embodiments.

It should be understood that the communication apparatus 1000 may correspond to the first node in the method 500 or the method 700 in embodiments of this application, or correspond to the gNB-DU #1 in the method 800 to the method 1000 in embodiments of this application. The communication apparatus 1000 may include units configured to perform the method performed by the first node in the method 500 or the method 700, or include units configured to perform the method performed by the gNB-DU #1 in the method 900 or the method 1000. In addition, units in the communication apparatus 1000 and the foregoing other operations and/or functions are respectively intended to implement corresponding procedures in the method 500 to the method 1000. It should be understood that specific processes of performing the foregoing corresponding steps by the units are described in detail in the foregoing method embodiments.

In another possible implementation, the communication apparatus 1000 may be the second node in the foregoing method embodiments, or may be a chip configured to implement a function of the second node in the foregoing method embodiments.

It should be understood that the communication apparatus 1000 may correspond to the second node in the method 500 or the method 700 in embodiments of this application, or correspond to the gNB-CU in the method 800 to the method 1000 in embodiments of this application. The communication apparatus 1000 may include units configured to perform the method performed by the second node in the method 500 or the method 700, or include units configured to perform the method performed by the gNB-CU in the method 900 or the method 1000. In addition, units in the communication apparatus 1000 and the foregoing other operations and/or functions are respectively intended to implement corresponding procedures in the method 500 to the method 1000. It should be understood that specific processes of performing the foregoing corresponding steps by the units are described in detail in the foregoing method embodiments.

In another possible implementation, the communication apparatus 1000 may be the third node in the foregoing method embodiments, or may be a chip configured to implement a function of the third node in the foregoing method embodiments.

It should be understood that the communication apparatus 1000 may correspond to the first node in the method 500 or the method 700 in embodiments of this application, or correspond to the gNB-DU #2 in the method 800 to the method 1000 in embodiments of this application. The communication apparatus 1000 may include units configured to perform the method performed by the first node in the method 500 or the method 700, or include units configured to perform the method performed by the gNB-DU #2 in the method 900 or the method 1000. In addition, units in the communication apparatus 1000 and the foregoing other operations and/or functions are respectively intended to implement corresponding procedures in the method 500 to the method 1000. It should be understood that specific processes of performing the foregoing corresponding steps by the units are described in detail in the foregoing method embodiments.

In another possible implementation, the communication apparatus 1000 may be the first terminal device in the foregoing method embodiments, or may be a chip configured to implement a function of the first terminal device in the foregoing method embodiments.

It should be understood that the communication apparatus 1000 may correspond to the first terminal device in the method 500 or the method 700 in embodiments of this application, or correspond to the UE in the method 800 to the method 1000 in embodiments of this application. The communication apparatus 1000 may include units configured to perform the method performed by the first terminal device in the method 500 or the method 700, or include units configured to perform the method performed by the UE in the method 900 or the method 1000. In addition, units in the communication apparatus 1000 and the foregoing other operations and/or functions are respectively intended to implement corresponding procedures in the method 500 to the method 1000. It should be understood that specific processes of performing the foregoing corresponding steps by the units are described in detail in the foregoing method embodiments.

It should be further understood that the transceiver unit 1010 in the communication apparatus 1000 may correspond to a transceiver 2020 in a communication device 2000 shown in FIG. 12, and the processing unit 1020 in the communication apparatus 1000 may correspond to a processor 2010 in the communication device 2000 shown in FIG. 12.

It should be further understood that, when the communication apparatus 1000 is a chip, the chip includes a transceiver unit. Optionally, the chip may further include a processing unit. The transceiver unit may be an input/output circuit or a communication interface. The processing unit may be a processor, a microprocessor, or an integrated circuit integrated on the chip.

The transceiver unit 1010 is configured to implement signal receiving and sending operations of the communication apparatus 1000, and the processing unit 1020 is configured to implement a signal processing operation of the communication apparatus 1000.

Optionally, the communication apparatus further includes a storage unit, and the storage unit is configured to store instructions.

FIG. 12 is a block diagram of a communication device 2000 according to an embodiment of this application. As shown in FIG. 12, the communication device 2000 includes at least one processor 2010 and a transceiver 2020. The processor 2010 is coupled to a memory, and is configured to execute instructions stored in the memory, to control the transceiver 2020 to send a signal and/or receive a signal. Optionally, the communication device 2000 further includes the memory 2030, configured to store the instructions.

It should be understood that the processor 2010 and the memory 2030 may be combined into one processing apparatus, and the processor 2010 is configured to execute program code stored in the memory 2030 to implement the foregoing functions. During specific implementation, the memory 2030 may alternatively be integrated into the processor 2010, or may be independent of the processor 2010.

It should be further understood that the transceiver 2020 may include a receiver (or referred to as a receiver machine) and a transmitter (or referred to as a transmitter machine). The transceiver 2020 may further include an antenna, and there may be one or more antennas. The transceiver 2020 may alternatively be an antenna interface or an interface circuit.

When the communication device 2000 is a chip, the chip includes a transceiver unit and a processing unit. The transceiver unit may be an input/output circuit or a communication interface. The processing unit may be a processor, a microprocessor, or an integrated circuit integrated on the chip.

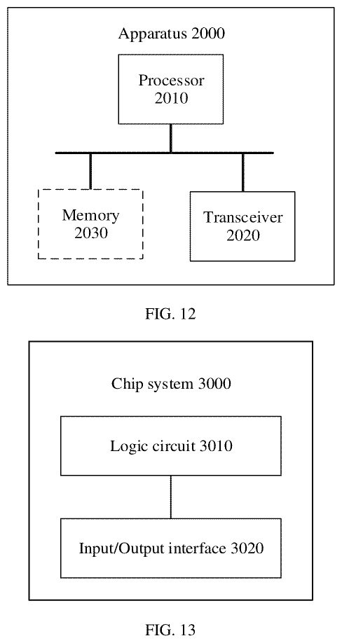

FIG. 13 is a diagram of a chip system according to an embodiment of this application. The chip system herein may alternatively be a system including a circuit. The chip system 3000 shown in FIG. 13 includes a logic circuit 3010 and an input/output (I/O) interface 3020. The logic circuit is configured to: be coupled to the input interface, and transmit data through the input/output interface, to perform the method in FIG. 5, FIG. 7, FIG. 8, FIG. 9, or FIG. 10.

An embodiment of this application further provides a processing apparatus, including a processor and an interface. The processor may be configured to perform the methods in the foregoing method embodiments.

It should be understood that the processing apparatus may be a chip. For example, the processing apparatus may be a field programmable gate array (FPGA), an application-specific integrated chip (ASIC), a system on chip (SoC), a central processing unit (CPU), a network processor (NP), a digital signal processing circuit (DSP), a micro controller unit (MCU), a programmable controller (PLD), or another integrated chip.

In an implementation process, steps in the foregoing methods can be implemented by using a hardware integrated logical circuit in the processor, or by using instructions in a form of software. The steps in the methods disclosed with reference to embodiments of this application may be performed and completed by a hardware processor, or may be performed and completed by a combination of hardware in the processor and a software module. The software module may be located in a mature storage medium in the art, for example, a random access register, a flash memory, a read-only memory, a programmable read-only memory, an electrically erasable programmable memory, or a register. The storage medium is located in the memory, and the processor reads information in the memory and completes the steps in the foregoing method in combination with the hardware in the processor.

It should be noted that, the processor in embodiments of this application may be an integrated circuit chip, and has a signal processing capability. In an implementation process, steps in the foregoing method embodiments can be implemented by using a hardware integrated logical circuit in the processor, or by using instructions in a form of software. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. It may implement or perform the methods, the steps, and logical block diagrams that are disclosed in embodiments of this application. The general-purpose processor may be a microprocessor, or the processor may be any conventional processor or the like.

It may be understood that the memory in this embodiment of this application may be a volatile memory or a nonvolatile memory, or may include a volatile memory and a nonvolatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache.

According to the methods provided in embodiments of this application, this application further provides a computer program product. The computer program product includes computer program code. When the computer program code is run on a computer, the computer is enabled to perform the method in FIG. 5, FIG. 7, FIG. 8, FIG. 9, or FIG. 10.

According to the methods provided in embodiments of this application, this application further provides a computer-readable storage medium. The computer-readable storage medium stores program code. When the program code is run on a computer, the computer is enabled to perform the method in FIG. 5, FIG. 7, FIG. 8, FIG. 9, or FIG. 10.

According to the methods provided in embodiments of this application, this application further provides a system, including the foregoing access network device and first device. Optionally, the system further includes a converged management function network element and/or a target network computing converged function node.

All or some of the foregoing embodiments may be implemented by using software, hardware, firmware, or any combination thereof. When the software is used for implementation, all or some of embodiments may be implemented in a form of computer program product. The computer program product includes one or more computer instructions. When the computer instructions are loaded and executed on the computer, the procedure or functions according to embodiments of this application are all or partially generated. The computer instructions may be stored in a computer-readable storage medium, or transmitted from one computer-readable storage medium to another computer-readable storage medium. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid state drive (SSD)), or the like.

In several embodiments mentioned in this application, it should be understood that the disclosed system, apparatus, and method may be implemented in other manners. For example, the foregoing apparatus embodiments are merely examples. For example, division of the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication method, comprising:
receiving, by a first terminal device, first information and second information from a first node, wherein the first information comprises common information for performing mobility management on at least one terminal device in at least one zone corresponding to a second node, the second information comprises dedicated information for performing mobility management on the first terminal device, the at least one zone comprises one zone served by the first node, and the at least one terminal device comprises the first terminal device;
performing, by the first terminal device and based on the first information and the second information, a mobility management procedure in the one zone served by the first node; and
receiving, by the first terminal device, updated second information from the first node.

2. The method according to claim 1, wherein the first node is a first satellite, and the second node is a second satellite or the second node is a terrestrial station corresponding to the first satellite.

3. The method according to claim 1, wherein the first information comprises at least one of:
an identity of an interface F1 application protocol (AP) between the first node and at least one node, a common measurement configuration, a common cell group configuration, a common radio bearer configuration, or a common reconfiguration with synchronization,
the at least one node comprises the first node, and
the second information comprises at least one of:
a dedicated measurement configuration of the first terminal device, a dedicated cell group configuration of the first terminal device, a dedicated radio bearer configuration of the first terminal device, and a dedicated reconfiguration with synchronization of the first terminal device.

4. The method according to claim 3, wherein the common measurement configuration comprises at least one of:
a synchronization signal block-based measurement timing configuration (SMTC), position information of the second node, and a measurement priority of the at least one zone, and
the common reconfiguration with synchronization comprises at least one of:
a time domain configuration, a preamble, or a frequency domain configuration of a random access channel occasion (RO) corresponding to target zone access in the mobility management procedure, and a validity period of the F1 AP.

5. The method according to claim 3, wherein the dedicated measurement configuration comprises at least one of:
a plurality of synchronization signal block-based measurement timing configurations (SMTC), an SMTC periodicity extension factor or an SMTC offset, and ephemeris information of the first node, and
the dedicated reconfiguration with synchronization comprises at least one of:
an extension factor and/or a quantity of consecutive frames of a random access channel occasion (RO) corresponding to target zone access in the mobility management procedure, and an offset of a validity period of the F1 AP.

6. The method according to claim 1, wherein receiving the first information and the second information from the first node comprises:
receiving, by the first terminal device, the first information and the second information from the first node in an initial access procedure of the first terminal device.

7. A communication apparatus, comprising:
at least one processor; and
one or more memories coupled to the at least one processor and storing program instructions for execution by the at least one processor to cause the communication apparatus to:
receive first information and second information from a first node, wherein the first information comprises common information for performing mobility management on at least one terminal device in at least one zone corresponding to a second node, the second information comprises dedicated information for performing mobility management on a first terminal device, the at least one zone comprises one zone served by the first node, and the at least one terminal device comprises the first terminal device;
perform, based on the first information and the second information, a mobility management procedure in the one zone served by the first node; and
receive updated second information from the first node.

8. The apparatus according to claim 7, wherein the first node is a first satellite, and the second node is a second satellite or the second node is a terrestrial station corresponding to the first satellite.

9. The apparatus according to claim 7, wherein the first information comprises at least one of:
an identity of an interface F1 application protocol (AP) between the first node and at least one node, a common measurement configuration, a common cell group configuration, a common radio bearer configuration, and a common reconfiguration with synchronization,
the at least one node comprises the first node, and
the second information comprises at least one of:
a dedicated measurement configuration of the apparatus, a dedicated cell group configuration of the apparatus, a dedicated radio bearer configuration of the apparatus, and a dedicated reconfiguration with synchronization of the apparatus.

10. The apparatus according to claim 9, wherein the common measurement configuration comprises at least one of:
a synchronization signal block-based measurement timing configuration (SMTC), position information of the second node, and a measurement priority of the at least one zone, and
the common reconfiguration with synchronization comprises at least one of:
a time domain configuration, a preamble, or a frequency domain configuration of a random access channel occasion (RO) corresponding to target zone access in the mobility management procedure, and a validity period of the F1 AP.

11. The apparatus according to claim 9, wherein the dedicated measurement configuration comprises at least one of:
a plurality of synchronization signal block-based measurement timing configurations (SMTC), an SMTC periodicity extension factor or an SMTC offset, and ephemeris information of the first node, and
the dedicated reconfiguration with synchronization comprises at least one of:
an extension factor and/or a quantity of consecutive frames of a random access channel occasion (RO) corresponding to target zone access in the mobility management procedure, and an offset of a validity period of the F1 AP.

12. The apparatus according to claim 7, wherein the apparatus is further caused to:
receive the first information and the second information from the first node in an initial access procedure of the apparatus.

13. A communication apparatus, comprising:
at least one processor; and
one or more memories coupled to the at least one processor and storing program instructions for execution by the at least one processor to cause the communication apparatus to:
send first information and second information to a first terminal device, wherein the first information comprises common information for performing mobility management on at least one terminal device in at least one zone corresponding to a second node, the second information comprises dedicated information for performing mobility management on the first terminal device, the at least one zone comprises one zone served by the apparatus, and the at least one terminal device comprises the first terminal device;
perform, based on a measurement report, a mobility management procedure of the first terminal device in the one zone served by the first node, wherein the measurement report is determined based on the first information and the second information; and
send updated second information to the first terminal device.

14. The apparatus according to claim 13, wherein the apparatus is a first satellite, and the second node is a second satellite or the second node is a terrestrial station corresponding to the first satellite.

15. The apparatus according to claim 13, wherein the first information comprises at least one of:
an identity of an interface F1 application protocol (AP) between the second node and at least one node, a common measurement configuration, a common cell group configuration, a common radio bearer configuration, and a common reconfiguration with synchronization,
the at least one node comprises the apparatus, and
the second information comprises at least one of:
a dedicated measurement configuration of the first terminal device, a dedicated cell group configuration of the first terminal device, a dedicated radio bearer configuration of the first terminal device, and a dedicated reconfiguration with synchronization of the first terminal device.

16. The apparatus according to claim 15, wherein the common measurement configuration comprises at least one of:
a synchronization signal block-based measurement timing configuration (SMTC), position information of the second node, and a measurement priority of the at least one zone, and
the common reconfiguration with synchronization comprises at least one of:
a time domain configuration, a preamble, or a frequency domain configuration of a random access channel occasion (RO) corresponding to target zone access in the mobility management procedure, and a validity period of the F1 AP.

17. The apparatus according to claim 15, wherein the dedicated measurement configuration comprises at least one of:
a plurality of synchronization signal block-based measurement timing configurations (SMTC), an SMTC periodicity extension factor or an SMTC offset, and ephemeris information of the first node, and
the dedicated reconfiguration with synchronization comprises at least one of:
an extension factor and/or a quantity of consecutive frames of a random access channel occasion (RO) corresponding to target zone access in the mobility management procedure, and an offset of a validity period of the F1 AP.

18. The apparatus according to claim 13, wherein the apparatus is further caused to:
receive the first information from the second node.

19. The apparatus according to claim 18, wherein the apparatus is further caused to:
receive the first information from the second node in an initial access procedure of the first terminal device.

20. The apparatus according to claim 13, wherein the apparatus is further caused to:
send the first information and the second information to the first terminal device in the initial access procedure of the first terminal device.
